(19) United States
(12) Patent Application Publication
(10) Pub. No.: US 2023/0209152 A1
(43) Pub. Date: Jun. 29, 2023

(54) METHOD FOR CREATING LIVE PREVIEW AND ELECTRONIC DEVICE

(71) Applicant: BEIJING DAJIA INTERNET INFORMATION TECHNOLOGY CO., LTD., Beijing (CN)

(72) Inventor: Ying WANG, Beijing (CN)

(21) Appl. No.: 17/930,481

(22) Filed: Sep. 8, 2022

(30) Foreign Application Priority Data
Dec. 24, 2021 (CN) 202111598839.6

(51) Int. Cl. H04N 21/8549; H04N 21/2187

(52) U.S. Cl. CPC H04N 21/8549; H04N 21/2187

(57) ABSTRACT

Provided is a method for creating a live streaming preview. The method includes: receiving a sticker display request from an anchor terminal of a first live room; generating, in response to the sticker display request, a first preview sticker based on first preview information corresponding to the live preview; and sending a sticker display instruction to an audience terminal in the first live room. The sticker display instruction carries the first preview sticker, and is configured to instruct the audience terminal to display the first preview sticker in a live streaming interface of the first live room.

### CROSS-REFERENCE TO RELATED APPLICATION

This application is based on and claims priority to Chinese Patent Application No. 202111598839.6, filed on Dec. 24, 2021, the disclosure of which is herein incorporated by reference in its entirety.

### TECHNICAL FIELD

The present disclosure relates to the field of Internet technologies, and in particular relates to a method for creating a live preview and an electronic device.

### BACKGROUND

Live streaming, as a trend, has been gradually integrated into people’s life. For example, entertainment-type live streaming can make audiences joyful, and shopping-type live streaming can promote audience consumption.

### SUMMARY

Embodiments of the present disclosure provide a method for creating a live preview and an electronic device. The technical solutions of the present disclosure are as follows.

According to some embodiments of the present disclosure, a method for creating a live preview is provided. The method includes:
receiving a sticker display request from a first terminal, wherein a first live room of the first terminal has been associated with a live preview, the first terminal being a terminal used by an anchor;
generating, in response to the sticker display request, a first preview sticker based on first preview information corresponding to the live preview; and
sending a sticker display instruction to a second terminal in the first live room, wherein the sticker display instruction carries the first preview sticker, and instructs the second terminal to display the first preview sticker in a live streaming interface of the first live room; and the second terminal is a terminal used by an audience.

In some embodiments, said generating, in response to the sticker display request, the first preview sticker based on the first preview information corresponding to the live preview includes:
acquiring the first preview information and sticker configuration information in response to the sticker display request; and
generating the first preview sticker based on the first preview information and the sticker configuration information.

In some embodiments, said generating the first preview sticker based on the first preview information and the sticker configuration information includes:
generating, in response to the sticker display request including a sticker create request, the first preview sticker based on the first preview information and the sticker configuration information.

In some embodiments, said generating the first preview sticker based on the first preview information and the sticker configuration information includes:
acquiring second preview information in response to the sticker display request including a sticker update request, wherein the second preview information is preview information corresponding to a second preview sticker which has been displayed in the first live room; and
generating, in response to the first preview information being different from the second preview information, the first preview sticker based on the first preview information and the sticker configuration information.

In some embodiments, there are a plurality of live rooms performing live streaming simultaneously with the first live room; and the method further includes:

respectively assigning sticker update requests of a plurality of live rooms to a plurality of sticker update tasks, wherein each sticker update task is assigned a sticker update request of at least one live room; and a sticker update task corresponding to the first live room includes acquiring the second preview information in response to the sticker display request including a sticker update request, and generating, in response to the first preview information being different from the second preview information, the first preview sticker based on the first preview information and the sticker configuration information.

In some embodiments, said acquiring the second preview information includes:

acquiring the second preview information from a first database, wherein the first database is configured to store preview information corresponding to a preview sticker which has been generated.

In some embodiments, acquiring the sticker configuration information includes:

acquiring the sticker configuration information from a second database, wherein the second database is a database corresponding to a configuration management platform.

In some embodiments, the live preview is provided with a reserve control configured to trigger reservation for the target live streaming; and the method further includes:
receiving a reserve request from the second terminal, wherein the reserve request is sent in response to the reserve control being triggered; and
updating preview information corresponding to the live preview in response to the reserve request.

In some embodiments, the method further includes:

receiving a cancel request from the first terminal, and sending a sticker cancel instruction to the second terminal, wherein the sticker cancel instruction instructs the second terminal to cancel display of the first preview sticker.

In some embodiments, the first preview information includes at least one of live streaming time, a live streaming theme, or a quantity of reservations; the sticker configuration information includes a sticker template; and
said generating the first preview sticker based on the first preview information and the sticker configuration information includes:
generating the first preview sticker based on the sticker template and at least one of the live streaming time, the live streaming theme, or the quantity of reservations.

In some embodiments, the method further includes:

providing a sticker display function for the first live room in response to the first live room of the first terminal has been associated with the live preview, wherein the first terminal is capable of triggering the sticker display request based on the sticker display function.

In some embodiments, said providing the sticker display function for the first live room in the case that the first live room of the first terminal has been associated with the live preview includes:

providing the sticker display function for the first live room in the case that the first live room of the first terminal has been associated with the live preview and a sticker status of the first live room satisfies a target condition.

In some embodiments, said determining whether the sticker status of the first live room satisfies the target condition includes:
querying for on/off status of a preview sticker control of the first live room, wherein the on/off status indicates whether displaying a preview sticker in the live streaming interface is allowed; and
determining that the sticker status satisfies the target condition in the case that the on/off status indicates that displaying the preview sticker in the live streaming interface is allowed; or
determining that the sticker status does not satisfy the target condition in the case that the on/off status indicates that displaying the preview sticker in the live streaming interface is not allowed.

In some embodiments, the method further includes:
receiving a configuration update request from the first terminal, wherein the configuration update request is triggered based on the preview sticker control of the first live room; and
updating the on/off status of the preview sticker control in response to the configuration update request.

In some embodiments, the method further includes:
receiving a control create request from the first terminal; and
creating the preview sticker control in response to the control create request.

In some embodiments, said querying for the on/off status of the preview sticker control of the first live room includes:

calling an application programming interface (API) corresponding to the preview sticker control, and querying for the on/off status of the preview sticker control.

According to some embodiments of the present disclosure, a method for creating a live preview is provided. The method includes:
displaying a live streaming interface of a first live room, wherein the first live room has been associated with a live preview;
sending a sticker display request to a server;
receiving a sticker display instruction from the server, wherein the sticker display instruction carries a first preview sticker which is generated, in response to the sticker display request, by the server based on first preview information corresponding to the live preview; and
displaying the first preview sticker in the live streaming interface in response to the sticker display instruction.

In some embodiments, the first preview sticker is also displayed in a live streaming interface of a second terminal in the first live room; the second terminal is a terminal used by an audience; and
the method further includes:
sending a cancel request to the server, wherein the cancel request is configured to request the server to send a sticker cancel instruction to the second terminal; and the sticker cancel instruction instructs the second terminal to cancel display of the first preview sticker.

In some embodiments, the sticker display request is sent in the case that a sticker status of the first live room satisfies a target condition; the sticker status satisfying the target condition means that on/off status of a preview sticker control of the first live room indicates that displaying a preview sticker in the live streaming interface is allowed; and the method further includes:
sending a configuration update request to the server, wherein the configuration update request is triggered based on the preview sticker control; and
receiving updated on/off status of the preview sticker control from the server, wherein the updated on/off status is acquired by updating the on/off status of the preview sticker control by the server in response to the configuration update request.

According to some embodiments of the present disclosure, an apparatus for creating a live preview is provided. The apparatus includes:
a first receiving unit configured to receive a sticker display request from a first terminal, wherein a first live room of the first terminal has been associated with a live preview, the first terminal being a terminal used by an anchor;
a generating unit configured to generate, in response to the sticker display request, a first preview sticker based on first preview information corresponding to the live preview; and
a first sending unit configured to send a sticker display instruction to a second terminal in the first live room, wherein the sticker display instruction carries the first preview sticker, and instructs the second terminal to display the first preview sticker in a live streaming interface of the first live room, the second terminal being a terminal used by an audience.

In some embodiments, the apparatus further includes:
an acquiring unit configured to acquire the first preview information and sticker configuration information in response to the sticker display request; and
the generating unit is configured to generate the first preview sticker based on the first preview information and the sticker configuration information.

In some embodiments, the generating unit is configured to generate, in response to the sticker display request including a sticker create request, the first preview sticker based on the first preview information and the sticker configuration information.

In some embodiments, the generating unit includes:
an acquiring sub-unit configured to acquire second preview information in response to the sticker display request including a sticker update request, wherein the second preview information is preview information corresponding to a second preview sticker which has been displayed in the first live room; and
a generating sub-unit configured to generate, in response to the first preview information being different from the second preview information, the first preview sticker based on the first preview information and the sticker configuration information.

In some embodiments, there are a plurality of live rooms performing live streaming simultaneously with the first live room; and the apparatus further includes:

an assigning unit configured to respectively assign sticker update requests of a plurality of live rooms to a plurality of sticker update tasks, wherein each sticker update task is assigned a sticker update request of at least one live room; and a sticker update task corresponding to the first live room includes acquiring the second preview information in response to the sticker display request including a sticker update request, and generating, in response to the first preview information being different from the second preview information, the first preview sticker based on the first preview information and the sticker configuration information.

In some embodiments, the acquiring sub-unit is configured to acquire the second preview information from a first database, wherein the first database is configured to store preview information corresponding to a preview sticker which has been generated.

In some embodiments, the acquiring unit is configured to acquire the sticker configuration information from a second database, wherein the second database is a database corresponding to a configuration management platform.

In some embodiments, the live preview is provided with a reserve control configured to trigger reservation for the target live streaming; and the apparatus further includes:
a second receiving unit configured to receive a reserve request from the second terminal, wherein the reserve request is sent in response to the reserve control being triggered; and
a first updating unit configured to update preview information corresponding to the live preview in response to the reserve request.

In some embodiments, the apparatus further includes:

a third receiving unit configured to: receive a cancel request from the first terminal, and send a sticker cancel instruction to the second terminal, wherein the sticker cancel instruction instructs the second terminal to cancel display of the first preview sticker.

In some embodiments, the first preview information includes at least one of live streaming time, a live streaming theme, or a quantity of reservations; the sticker configuration information includes a sticker template; and

the generating unit is configured to generate the first preview sticker based on the sticker template and at least one of the live streaming time, the live streaming theme, or the quantity of reservations.

In some embodiments, the first receiving unit is configured to provide a sticker display function for the first live room in the case that the first live room of the first terminal has been associated with the live preview, wherein the first terminal is capable of triggering the sticker display request based on the sticker display function.

In some embodiments, the first receiving unit is configured to provide the sticker display function for the first live room in the case that the first live room of the first terminal has been associated with the live preview and a sticker status of the first live room satisfies a target condition.

In some embodiments, the first receiving unit includes:
a querying sub-unit configured to query for on/off status of a preview sticker control of the first live room, wherein the on/off status indicates whether displaying a preview sticker in the live streaming interface is allowed;
a first determining sub-unit configured to determine that the sticker status satisfies the target condition in the case that the on/off status indicates that displaying the preview sticker in the live streaming interface is allowed; and
a second determining sub-unit configured to determine that the sticker status does not satisfy the target condition in the case that the on/off status indicates that displaying the preview sticker in the live streaming interface is not allowed.

In some embodiments, the apparatus further includes:
a fourth receiving unit configured to receive a configuration update request from the first terminal, wherein the configuration update request is triggered based on the preview sticker control of the first live room; and
a second updating unit configured to update the on/off status of the preview sticker control in response to the configuration update request.

In some embodiments, the apparatus further includes:
a fifth receiving unit configured to receive a control create request from the first terminal; and
a creating unit configured to create the preview sticker control in response to the control create request.

In some embodiments, the querying sub-unit is configured to: call an API corresponding to the preview sticker control, and query for the on/off status of the preview sticker control.

According to some embodiments of the present disclosure, an apparatus for creating a live preview is provided. The apparatus includes:
a first displaying unit configured to display a live streaming interface of a first live room, wherein the first live room has been associated with a live preview;
a second sending unit configured to send a sticker display request to a server;
a sixth receiving unit configured to receive a sticker display instruction from the server, wherein the sticker display instruction carries a first preview sticker which is generated, in response to the sticker display request, by the server based on first preview information corresponding to the live preview; and
a second displaying unit configured to display the first preview sticker in the live streaming interface in response to the sticker display instruction.

In some embodiments, the first preview sticker is also displayed in a live streaming interface of a second terminal in the first live room; the second terminal is a terminal used by an audience; and

the apparatus further includes:

a third sending unit configured to send a cancel request to the server, wherein the cancel request is configured to request the server to send a sticker cancel instruction to the second terminal; and the sticker cancel instruction instructs the second terminal to cancel display of the first preview sticker.

In some embodiments, the sticker display request is sent in the case that a sticker status of the first live room satisfies a target condition; the sticker status satisfying the target condition means that on/off status of a preview sticker control of the first live room indicates that displaying a preview sticker in the live streaming interface is allowed; and the apparatus further includes:
a fourth sending unit configured to send a configuration update request to the server, wherein the configuration update request is triggered based on the preview sticker control of the first live room; and
a seventh receiving unit configured to receive updated on/off status of the preview sticker control from the server, wherein the updated on/off status is acquired by updating the on/off status of the preview sticker control by the server in response to the configuration update request.

According to some embodiments of the present disclosure, an electronic device is provided. The electronic device includes:
one or more processors; and
a memory configured to store one or more instructions executable by the one or more processors,
wherein the one or more processors, when loading and executing the one or more instructions, are caused to perform the method for creating the live preview as defined in the aforementioned embodiments.

According to some embodiments of the present disclosure, a non-transitory computer-readable storage medium storing one or more instructions therein, wherein the one or more instructions, when loaded and executed by a processor of an electronic device, cause the electronic device to perform the method for creating the live preview as defined in the aforementioned embodiments.

According to some embodiments of the present disclosure, a computer program product is provided. The computer program product includes a computer program, wherein the computer program, when executed by a processor, causes the processor to perform the method for creating the live preview as defined in the aforementioned embodiments.

It should be understood that the above general descriptions and the following detailed descriptions are only exemplary and explanatory, and should not be construed as a limitation to the present disclosure.

### BRIEF DESCRIPTION OF THE DRAWINGS

FIG. 1 is a schematic diagram of an implementation environment according to some embodiments of the present disclosure;

FIG. 2 is a flowchart of a method for creating a live preview according to some embodiments of the present disclosure;

FIG. 3 is a flowchart of a method for creating a live preview according to some embodiments of the present disclosure;

FIG. 4 is a flowchart of a method for creating a live preview according to some embodiments of the present disclosure;

FIG. 5 is a flowchart of a method for creating a live preview according to some embodiments of the present disclosure;

FIG. 6 is a flowchart of a method for creating a live preview according to some embodiments of the present disclosure;

FIG. 7 is a flowchart of a method for creating a live preview according to some embodiments of the present disclosure;

FIG. 8 is a flowchart of a method for creating a live preview according to some embodiments of the present disclosure;

FIG. 9 is a flowchart of a method for creating a live preview according to some embodiments of the present disclosure;

FIG. 10 is a schematic diagram of a method for creating a live preview according to some embodiments of the present disclosure;

FIG. 11 is a schematic diagram of a method for creating a live preview according to some embodiments of the present disclosure;

FIG. 12 is a block diagram of an apparatus for creating a live preview according to some embodiments of the present disclosure;

FIG. 13 is a block diagram of an apparatus for creating a live preview according to some embodiments of the present disclosure;

FIG. 14 is a block diagram of a terminal according to some embodiments of the present disclosure; and

FIG. 15 is a block diagram of a server according to some embodiments of the present disclosure.

### DETAILED DESCRIPTION

It should be noted that, user information (including but is not limited to user equipment information, user personal information, and the like) in the present disclosure is information authorized by a user or sufficiently authorized by all parties.

Terms “at least one”, “a plurality of”, “each”, and “any” are used in the present disclosure, wherein “at least one” indicates one, two, or more; “a plurality of” indicates two or more; “each” indicates each of “a plurality of”; and “any” indicates any of “a plurality of”.

Live streaming, as a trend, has been gradually integrated into people’s life. For example, entertainment-type live streaming can bring joy to audiences, and shopping-type live streaming can promote audiences consumption. To increase the number of audiences watching live streaming, preview information of the live streaming needs to be output to an audience in advance before the live streaming starts, such that the audience can watch the live streaming based on the preview information. Therefore, how to create a live preview before the live streaming starts is very important for increasing the view rate of the live streaming.

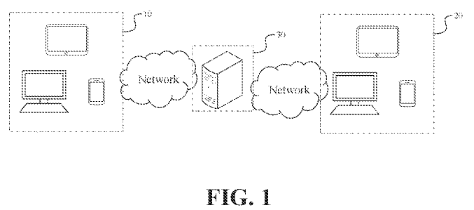

FIG. 1 is a schematic diagram of an implementation environment according to some embodiments of the present disclosure. Referring to FIG. 1, the application environment includes a first terminal 10, a second terminal 20, and a server 30. The server 30 is separately connected to the first terminal 10 and the second terminal 20 over a network. The first terminal 10 is a terminal for an anchor. The second terminal 20 is a terminal for an audience, and the number of the second terminals 20 is one or more. In some embodiments, both the first terminal 10 and the second terminal 20 run live streaming applications. The live streaming application in the first terminal 10 provides a function of carrying out live streaming. The anchor can carry out live streaming via the live streaming application. The first terminal 10 is configured to send a sticker display request to the server 30. The server 30 is configured to generate a preview sticker based on the sticker display request, and send the preview sticker to the second terminal 20, wherein the preview sticker is configured to preview live streaming whose live preview has been created. The live streaming application in the second terminal 20 provides a function of watching live streaming. The audience can enter a live room via the live streaming application to watch live streaming. The second terminal 20 displays, in a live streaming interface of the live room, the preview sticker sent by the server 30, such that the audience can acquire pre- live streaming announcement information when watching the live streaming.

In some embodiments, each of the first terminal 10 and the second terminal 20 is at least one of the following devices: a smart phone, a smart watch, a desktop computer, a portable computer, a virtual reality terminal, an augmented reality computer, a wireless terminal, a laptop portable computer, and the like. The server 30 is a backend server of the live streaming applications, and may be an independent physical server 30, a server cluster consisting of a plurality of physical servers, a distributed file system, or a cloud server providing cloud services, cloud databases, cloud computing, cloud functions, cloud storage, network services, cloud communication, middleware services, domain name services, security services, a content delivery network (CDN), big data and artificial intelligence platforms, and other basic cloud computing services.

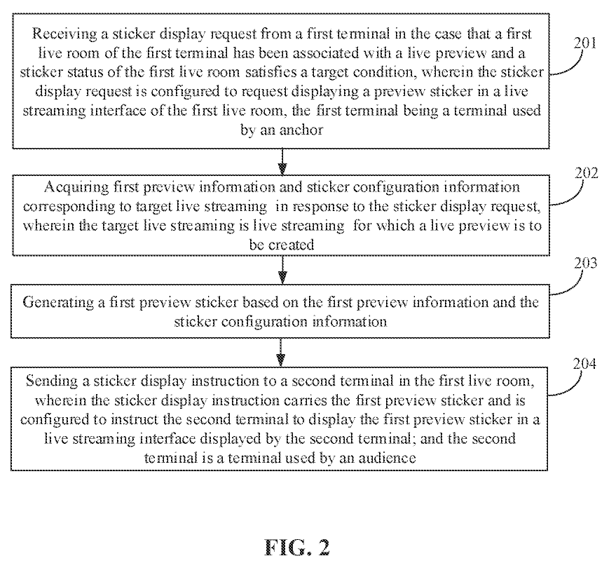

FIG. 2 is a flowchart of a method for creating a live preview according to some embodiments of the present disclosure. The method is executed by a server and includes the following steps.

In step 201, a sticker display request from a first terminal is received in the case that a first live room of the first terminal has been associated with a live preview and a sticker status of the first live room satisfies a target condition, wherein the sticker display request is configured to request displaying a preview sticker in a live streaming interface of the first live room, the first terminal being a terminal used by an anchor.

It can be learned from step 201 that when the server receives the sticker display request from the first terminal, the first live room of the first terminal has been associated with the live preview.

In step 202, first preview information and sticker configuration information corresponding to target live streaming are acquired in response to the sticker display request, wherein the target live streaming is live streaming for which a live preview is to be created.

The target live streaming refers to the live streaming for which the live preview is to be created, that is, the target live streaming is the live streaming to be previewed or the live preview is created for the target live streaming and the target live streaming is not currently displaying in the first live room. Therefore, the first preview information of the target live streaming is first preview information corresponding to the live preview.

In step 203, a first preview sticker is generated based on the first preview information and the sticker configuration information.

It step 203, the server generates the first preview sticker based on the first preview information and the sticker configuration information. Alternatively, in step 203, the server generates the first preview sticker based on the first preview information.

In step 204, a sticker display instruction is sent to a second terminal in the first live room, wherein the sticker display instruction carries the first preview sticker and is configured to instruct the second terminal to display the first preview sticker in a live streaming interface displayed by the second terminal; and the second terminal is a terminal used by an audience.

Because the second terminal is a terminal participating in the first live room, the live streaming interface displayed by the second terminal is the live streaming interface of the first live room.

In some embodiments, said the first preview sticker is generated based on the first preview information and the sticker configuration information includes:

generating, in response to the sticker display request including a sticker create request, the first preview sticker based on the first preview information and the sticker configuration information.

In some embodiments, said the first preview sticker is generated based on the first preview information and the sticker configuration information includes:
acquiring second preview information in response to the sticker display request including a sticker update request, wherein the second preview information is preview information corresponding to a second preview sticker which has been displayed in the first live room; and
generating, in response to the first preview information being different from the second preview information, the first preview sticker based on the first preview information and the sticker configuration information.

In some embodiments, there are a plurality of live rooms performing live streaming simultaneously and the plurality of live rooms include the first live room; and the method for creating the live preview further includes:

respectively assigning sticker update requests of a plurality of live rooms to a plurality of sticker update tasks, wherein each sticker update task is assigned a sticker update request of at least one live room; and a sticker update task corresponding to the first live room is configured to perform the following steps: acquiring second preview information in response to the sticker display request including the sticker update request, wherein the second preview information is preview information corresponding to a second preview sticker which has been displayed in the first live room; and generating, in response to the first preview information being different from the second preview information, the first preview sticker based on the first preview information and the sticker configuration information.

In some embodiments, said acquiring the second preview information includes:

acquiring the second preview information from a first database, wherein the first database is configured to store preview information corresponding to a preview sticker which has been generated.

In some embodiments, said acquiring the sticker configuration information includes:

acquiring the sticker configuration information from a second database, wherein the second database is a database corresponding to a configuration management platform.

In some embodiments, the live preview is provided with a reserve control configured to trigger reservation for the target live streaming; and the method for creating the live preview further includes:
receiving a reserve request from the second terminal, wherein the reserve request is sent in response to the reserve control being triggered; and
updating preview information of the target live streaming in response to the reserve request.

In some embodiments, the method for creating the live preview further includes:

receiving a cancel request from the first terminal, and sending a sticker cancel instruction to the second terminal, wherein the sticker cancel instruction is configured to instruct the second terminal to cancel the first preview sticker which has been displayed.

In some embodiments, the first preview information includes at least one of live streaming time, a live streaming theme, or a quantity of reservations; the sticker configuration information includes a sticker template; and
said the first preview sticker is generated based on the first preview information and the sticker configuration information includes:
generating the first preview sticker based on the sticker template and at least one of the live streaming time, the live streaming theme, or the quantity of reservations.

In some embodiments, said the sticker display request from the first terminal is received in response to the first live room of the first terminal having been associated with the live preview and the sticker status of the first live room satisfying the target condition includes:

providing a sticker display function for the first live room in the case that the first live room of the first terminal has been associated with the live preview, wherein the first terminal is capable of triggering the sticker display request based on the sticker display function, and receiving the sticker display request from the first terminal in the case that the sticker status of the first live room satisfies the target condition.

In some embodiments, said determining whether the sticker status of the first live room satisfies the target condition includes:
querying for on/off status of a preview sticker control of the first live room, wherein the on/off status indicates whether displaying a preview sticker in the live streaming interface is allowed; and
determining that the sticker status satisfies the target condition in the case that the on/off status indicates that displaying the preview sticker in the live streaming interface is allowed; or determining that the sticker status does not satisfy the target condition in the case that the on/off status indicates that displaying the preview sticker in the live streaming interface is not allowed.

In some embodiments, the method for creating the live preview further includes:
receiving a configuration update request from the first terminal, wherein the configuration update request is triggered based on the preview sticker control of the first live room, and is configured to request updating the on/off status of the preview sticker control; and
updating the on/off status of the preview sticker control in response to the configuration update request.

In some embodiments, before said querying for the on/off status of the preview sticker control of the first live room, the method for creating the live preview further includes:
receiving a control create request from the first terminal, wherein the control create request is configured to request creating the preview sticker control of the first live room; and
creating the preview sticker control in response to the control create request.

In some embodiments, said querying for the on/off status of the preview sticker control of the first live room includes:
calling an API corresponding to the preview sticker control; and
querying for the on/off status of the preview sticker control through the API.

According to the method for creating the live preview in this embodiment of the present disclosure, a preview sticker of live streaming can be generated based on preview information and sticker configuration information of the live streaming; and the preview sticker can be displayed on a live streaming interface of a second terminal in a first live room. In this way, the audience can acquire the preview information of target live streaming when watching the live streaming at the first live room, such that an amount of information displayed in the live streaming interface is increased and efficiency of outputting the information to the audience is improved. Therefore, the preview effect of the live preview is improved.

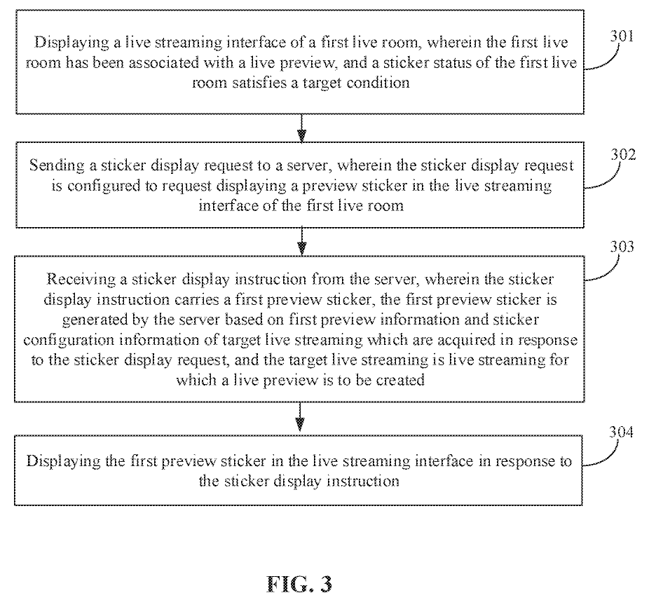

FIG. 3 is a flowchart of a method for creating a live preview according to some embodiments of the present disclosure. The method for creating the live preview is executed by a first terminal or an anchor terminal. As shown in FIG. 3, the method includes the following steps.

In step 301, a live streaming interface of a first live room is displayed, wherein the first live room has been associated with a live preview, and a sticker status of the first live room satisfies a target condition.

In step 302, a sticker display request is sent to a server, wherein the sticker display request is configured to request displaying a preview sticker in the live streaming interface of the first live room.

In step 303, a sticker display instruction from the server is received, wherein the sticker display instruction carries a first preview sticker; the first preview sticker is generated by the server based on first preview information and sticker configuration information of target live streaming and the first preview information and the sticker configuration information of the target live streaming are acquired in response to the sticker display request, and the target live streaming is live streaming for which the live preview is to be created.

The target live streaming is the live streaming for which the live preview is to be created, that is, the live preview associated with the first live room is the live preview corresponding to the target live streaming. Therefore, the first preview information of the target live streaming is first preview information corresponding to the live preview. In step 303, the first preview sticker is generated by the server, in response to the sticker display request, based on the first preview information corresponding to the live preview and the sticker configuration information. Alternatively, the first preview sticker is generated based on the first preview information corresponding to the live preview.

In step 304, the first preview sticker is displayed in the live streaming interface in response to the sticker display instruction.

In some embodiments, the first preview sticker is also displayed in a live streaming interface of a second terminal; the second terminal is a terminal used by an audience, and the method for creating the live preview further includes:

sending a cancel request to the server, wherein the cancel request is configured to request the server to send a sticker cancel instruction to the second terminal; and the sticker cancel instruction instructs the second terminal to cancel the first preview sticker which has been displayed.

In some embodiments, the target condition is satisfied in the case that on/off status of a preview sticker control of the first live room indicates that displaying a preview sticker in the live streaming interface is allowed; and the method for creating the live preview further includes:
sending a configuration update request to a server, wherein the configuration update request is triggered based on the preview sticker control of the first live room, and is configured to request updating the on/off status of the preview sticker control; and
receiving updated on/off status of the preview sticker control from the server, wherein the updated on/off status is acquired by updating the on/off status of the preview sticker control by the server in response to the configuration update request.

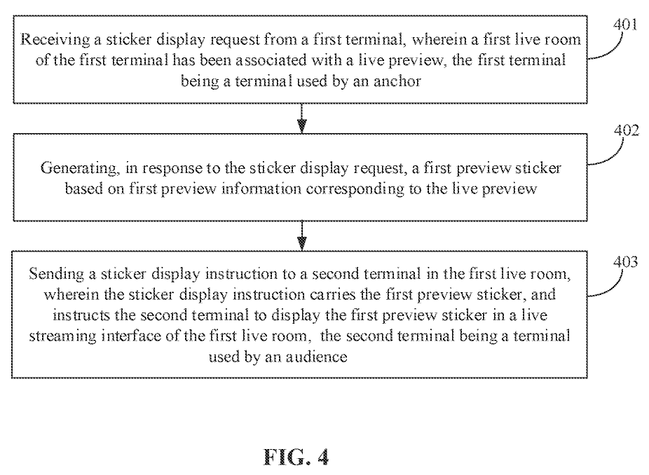

FIG. 4 is a flowchart of a method for creating a live preview according to some embodiments. The method is executed by a server and includes the following steps.

In step 401, a sticker display request from a first terminal is received, wherein a first live room of the first terminal has been associated with a live preview, the first terminal being a terminal used by an anchor.

In step 402, a first preview sticker is generated in response to the sticker display request based on first preview information corresponding to the live preview.

In step 403, a sticker display instruction is sent to a second terminal in the first live room, wherein the sticker display instruction carries the first preview sticker, and is configured to instruct the second terminal to display the first preview sticker in a live streaming interface of the first live room; and the second terminal is a terminal used by an audience.

In some embodiments, said the first preview sticker is generated in response to the sticker display request based on the first preview information corresponding to the live preview includes:
acquiring the first preview information and sticker configuration information in response to the sticker display request; and
generating the first preview sticker based on the first preview information and the sticker configuration information.

In some embodiments, said the first preview sticker is generated based on the first preview information and the sticker configuration information includes:

generating, in response to the sticker display request including a sticker create request, the first preview sticker based on the first preview information and the sticker configuration information.

In some embodiments, said the first preview sticker is generated based on the first preview information and the sticker configuration information includes:
acquiring second preview information in response to the sticker display request including a sticker update request, wherein the second preview information is preview information corresponding to a second preview sticker which has been displayed in the first live room; and
generating, in response to the first preview information being different from the second preview information, the first preview sticker based on the first preview information and the sticker configuration information.

In some embodiments, a plurality of live rooms including the first live room are performing live streaming simultaneously ; and the method further includes:

respectively assigning sticker update requests of a plurality of live rooms to a plurality of sticker update tasks, wherein each sticker update task is assigned a sticker update request of at least one live room, and a sticker update task corresponding to the first live room includes acquiring the second preview information in response to the sticker display request including a sticker update request, and generating, in response to the first preview information being different from the second preview information, the first preview sticker based on the first preview information and the sticker configuration information.

In some embodiments, said acquiring the second preview information includes:

acquiring the second preview information from a first database, wherein the first database is configured to store preview information corresponding to a preview sticker which has been generated.

In some embodiments, acquiring the sticker configuration information includes:

acquiring the sticker configuration information from a second database, wherein the second database is a database corresponding to a configuration management platform.

In some embodiments, the live preview is provided with a reserve control configured to trigger reservation for the target live streaming; and the method further includes:
receiving a reserve request from the second terminal, wherein the reserve request is sent in response to the reserve control being triggered; and
updating preview information corresponding to the live preview in response to the reserve request.

In some embodiments, the method further includes:

receiving a cancel request from the first terminal, and sending a sticker cancel instruction to the second terminal, wherein the sticker cancel instruction instructs the second terminal to cancel display of the first preview sticker.

In some embodiments, the first preview information includes at least one of live streaming time, a live streaming theme, or a quantity of reservations; the sticker configuration information includes a sticker template; and
said the first preview sticker is generated based on the first preview information and the sticker configuration information includes:
generating the first preview sticker based on the sticker template and at least one of the live streaming time, the live streaming theme, or the quantity of reservations.

In some embodiments, the method further includes:

providing a sticker display function for the first live room in the case that the first live room of the first terminal has been associated with the live preview, wherein the first terminal is capable of triggering the sticker display request based on the sticker display function.

In some embodiments, said providing the sticker display function for the first live room in the case that the first live room of the first terminal has been associated with the live preview includes:

providing the sticker display function for the first live room in the case that the first live room of the first terminal has been associated with the live preview and a sticker status of the first live room satisfies a target condition.

In some embodiments, said determining whether the sticker status of the first live room satisfies the target condition includes:
querying for on/off status of a preview sticker control of the first live room, wherein the on/off status indicates whether displaying a preview sticker in the live streaming interface is allowed; and
determining that the sticker status satisfies the target condition in the case that the on/off status indicates that displaying the preview sticker in the live streaming interface is allowed; or
determining that the sticker status does not satisfy the target condition in the case that the on/off status indicates that displaying the preview sticker in the live streaming interface is not allowed.

In some embodiments, the method further includes:
receiving a configuration update request from the first terminal, wherein the configuration update request is triggered based on the preview sticker control of the first live room; and
updating the on/off status of the preview sticker control in response to the configuration update request.

In some embodiments, the method further includes:
receiving a control create request from the first terminal; and
creating the preview sticker control in response to the control create request.

In some embodiments, said querying for the on/off status of the preview sticker control of the first live room includes:

calling an API corresponding to the preview sticker control, and querying for the on/off status of the preview sticker control.

According to the method for creating the live preview in this embodiment of the present disclosure, a preview sticker corresponding to a live preview can be generated based on preview information corresponding to the live preview, and the preview sticker can be displayed on a live streaming interface of a second terminal in a first live room. In this way, the audience can acquire preview information corresponding to live streaming to be carried out when watching the live streaming, such that the amount of information displayed in the live streaming interface and efficiency of outputting the information to the audience are improved. Therefore, the preview effect of a live preview is improved.

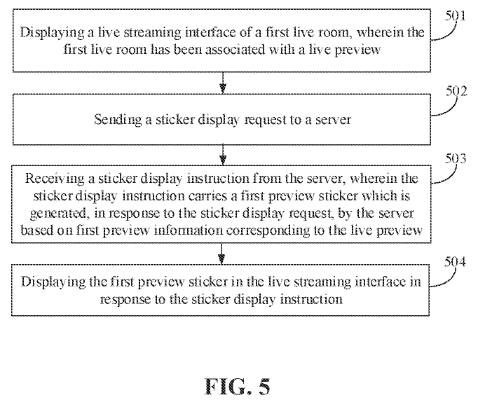

FIG. 5 is a flowchart of a method for creating a live preview according to some embodiments of the present disclosure. The method for creating the live preview is executed by a first terminal. As shown in FIG. 5, the method includes the following steps.

In step 501, a live streaming interface of a first live room is displayed, wherein the first live room has been associated with a live preview.

In step 502, a sticker display request is sent to a server.

In step 503, a sticker display instruction from the server is received, wherein the sticker display instruction carries a first preview sticker which is generated by the server, in response to the sticker display request, based on first preview information corresponding to the live preview.

In step 504, the first preview sticker is displayed in the live streaming interface in response to the sticker display instruction.

In some embodiments, the first preview sticker is also displayed in a live streaming interface of a second terminal in the first live room, the second terminal is a terminal used by an audience; and

the method further includes:

sending a cancel request to the server, wherein the cancel request is configured to request the server to send a sticker cancel instruction to the second terminal; and the sticker cancel instruction instructs the second terminal to cancel display of the first preview sticker.

In some embodiments, the sticker display request is sent in the case that a sticker status of the first live room satisfies a target condition; the sticker status satisfying the target condition means that on/off status of a preview sticker control of the first live room indicates that displaying a preview sticker in the live streaming interface is allowed; and the method further includes:
sending a configuration update request to the server, wherein the configuration update request is triggered based on the preview sticker control; and
receiving updated on/off status of the preview sticker control from the server, wherein the updated on/off status is acquired by updating the on/off status of the preview sticker control by the server in response to the configuration update request.

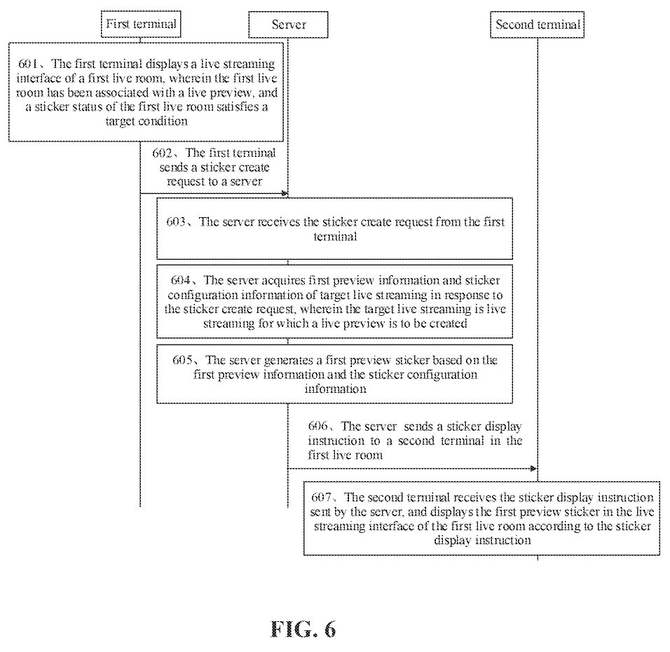

FIG. 6 is a flowchart of a method for creating a live preview according to some embodiments of the present disclosure. The method includes the following steps to describe a process of creating a preview sticker.

In step 601, a first terminal displays a live streaming interface of a first live room, wherein the first live room has been associated with a live preview, and a sticker status of the first live room satisfies a target condition.

The first terminal is a terminal used by an anchor. The terminal used by the anchor is a terminal which an account of the anchor is logged-in. The first live room is a live room in which live streaming is carried out currently. In some embodiments, the first terminal enables a live streaming application on the first terminal in response to a triggering operation of the anchor on the first terminal, wherein the live streaming application displays a live streaming control, and the live streaming control is configured to display a live streaming interface when being triggered, and the live streaming interface of the first live room is displayed in an interface of the live streaming application if the live streaming control is triggered.

In some embodiments, said the first live room has been associated with the live preview means that an anchor’s account of the first live room has created the live preview. In some other embodiments, said the first live room has been associated with the live preview means that an association relationship has been established between the first live room and the live preview. For example, the live preview is created by the anchor’s account of the first live room; or the live preview is created by an anchor’s account of another live room.

In some embodiments, the first terminal queries for on/off status of a preview sticker control of the first live room, wherein the on/off status indicates whether displaying a preview sticker in the live streaming interface is allowed; and determines that the sticker status satisfies the target condition in the case that the on/off status indicates that displaying the preview sticker in the live streaming interface is allowed; or determines that the sticker status does not satisfy the target condition in the case that the on/off status indicates that displaying the preview sticker in the live streaming interface is not allowed. In some embodiments, the first terminal determines that the first live room has been associated with the live preview in the case that the on/off status indicates that displaying the preview sticker in the live streaming interface is allowed.

In step 602, the first terminal sends a sticker create request to a server.

The sticker create request is configured to request displaying the preview sticker in the live streaming interface of the first live room. In some embodiments, the first terminal sends the sticker create request to the server only after determining that the first live room has been associated with the live preview and that the sticker status of the first live room satisfies the target condition. In some embodiments, the first terminal sends the sticker create request to the server in response to the live streaming interface being displayed or the live streaming control being triggered. In some embodiments, the live streaming interface of the first live room displays a sticker display control; and the first terminal sends the sticker create request to the server in response to the sticker display control in the live streaming interface being triggered. The sticker display control is a sticker display function provided by the server for the first live room.

In step 603, the server receives the sticker create request from the first terminal.

In some embodiments, the server provides the sticker display function for the first live room in the case that the first live room of the first terminal has been associated with the live preview; and the first terminal is capable of triggering the sticker create request based on the sticker display function. In some embodiments, the server provides the sticker display function for the first live room in the case that the first live room of the first terminal has been associated with the live preview and the sticker status of the first live room satisfies the target condition.

In some embodiments, said the server provides the sticker display function for the first live room means creating a sticker display control in the live streaming interface of the first live room, and the first terminal sends the sticker create request to the server in response to the sticker display control being triggered. In some other embodiments, the sticker display function is to send by the server, to the first terminal in the case that the first live room of the first terminal has been associated with the live preview, a check result that the live preview has been associated with the first live room; and the first terminal sends the sticker create request to the server based on the check result.

In this embodiment of the present disclosure, the server provides the sticker display function for the live room associated with the live preview to facilitate distinguishing between the live room associated with the live preview and a live room not associated with any live preview, such that the server can receive only the sticker create request of the live room associated with the live preview, thereby reducing traffic consumed by the server in receiving the sticker create request. Therefore, convenience is brought for subsequent generating the preview sticker by the server according to the sticker create request and displaying the preview sticker in the live room.

A process in which the server determines whether the sticker status of the first live room satisfies the target condition includes the following steps (1) and (2).

In step (1), the server queries for the on/off status of the preview sticker control of the first live room, wherein the on/off status indicates whether displaying a preview sticker in the live streaming interface is allowed.

It should be noted that, a process of creating the preview sticker control includes: sending the control create request by the first terminal to the server; receiving, by the server, the control create request from the first terminal, wherein the control create request is configured to request creating the preview sticker control of the first live room; and creating the preview sticker control by the server in response to the control create request. In this embodiment of the present disclosure, the preview sticker control is created, such that the anchor can control, by controlling the on/off status of the preview sticker control, whether to display the preview sticker in the live streaming interface of the first live room. Therefore, flexibility of displaying the preview sticker is improved.

A process of updating the on/off status includes: sending a configuration update request by the first terminal to the server; receiving the configuration update request from the first terminal by the server, wherein the configuration update request is triggered based on the preview sticker control of the first live room, and is configured to request updating the on/off status of the preview sticker control; and updating the on/off status of the preview sticker control by the server in response to the configuration update request. In this embodiment of the present disclosure, the on/off status of the preview sticker control is updated, such that whether the anchor allows displaying the preview sticker in the live room can be determined in time based on the updated on/off status. Therefore, flexibility of controlling, by the anchor based on the preview sticker control, whether to display the preview sticker in the live room is improved. In some embodiments, a sticker remove instruction is sent to the first terminal in the case that the updated on/off status indicates that displaying the preview sticker in the live streaming interface is not allowed, wherein the sticker remove instruction is configured to instruct the first terminal to cancel the live preview associated with the first live room. When the first terminal cancels the live preview associated with the first live room, the first live room is not associated with any live preview. In this case, the first terminal is incapable of sending the sticker create request to the server. Therefore, the live streaming interface is incapable of displaying the preview sticker.

In some embodiments, the first terminal receives the updated on/off status of the preview sticker control from the server, wherein the on/off status is acquired by updating the on/off status of the preview sticker control by the server in response to the configuration update request. In this embodiment of the present disclosure, the first terminal receives the updated on/off status of the preview sticker control from the server, such that the on/off status of the preview sticker control on the first terminal can be updated in time. Then, the anchor can determine, in time based on the updated on/off status of the first terminal, whether the on/off status is updated successfully.

In step (2), the server determines that the sticker status satisfies the target condition in the case that the on/off status indicates that displaying the preview sticker in the live streaming interface is allowed.

In some embodiments, the server calls an application programming interface (API) corresponding to the preview sticker control, and queries for the on/off status of the preview sticker control. In this embodiment of the present disclosure, the on/off status of the preview sticker control is determined through the API, such that information about the on/off status of the preview sticker control can be transmitted fast and efficiently between the server and the first terminal.

In some embodiments, the server determines that the sticker status does not satisfy the target condition in the case that the on/off status indicates that displaying the preview sticker in the live streaming interface is not allowed. In this embodiment of the present disclosure, the on/off status of the preview sticker control is determined, such that when it is determined that the on/off status indicates that displaying the preview sticker in the live streaming interface is not allowed, it can be determined conveniently that the sticker status does not satisfy the target condition. Therefore, the process can be ended directly in the case that the sticker status does not satisfy the target condition. This avoids resource waste caused by performing a subsequent step in the case that the sticker status does not satisfy the target condition.

In this embodiment of the present disclosure, whether displaying the preview sticker in the live streaming interface is allowed is indicated by the on/off status of the preview sticker control presented on the live streaming interface, such that the anchor can directly and fast control, by controlling the preview sticker control, whether to display the preview sticker in the live streaming interface. Therefore, flexibility of control over displaying of the preview sticker is improved.

In step 604, the server acquires first preview information and sticker configuration information of target live streaming in response to the sticker create request, wherein the target live streaming is live streaming for which a live preview is to be created.

The target live streaming is live streaming corresponding to the live preview associated with the first live room or the live streaming to be previewed. That is, the target live streaming is not currently performing in the first live room. The live preview is configured to enable an audience to preview the target live streaming. The first preview information of the target live streaming is first preview information corresponding to the live preview. For example, the live preview includes the first preview information.

It should be noted that, the first preview information is original preview information of the target live streaming. The server acquires the first preview information created by the anchor via the first terminal, and writes the first preview information into a remote dictionary server (redis) database for storage. The first preview information includes at least one of live streaming time, a live streaming theme, or a quantity of reservations. Because the first preview information is the original preview information of the target live streaming, the quantity of reservations in the first preview information is 0.

The sticker configuration information is sticker information configured in advance. The server acquires the sticker configuration information from a second database, wherein the second database is a database corresponding to a configuration management platform; and the configuration management platform is configured to manage the sticker configuration information. For example, the database corresponding to the configuration management platform is a database in a server corresponding to the configuration management platform. The server corresponding to the configuration management platform is the same as or different from a server configured to create the preview sticker in this embodiment of the present disclosure. In some embodiments, the second database is a MySQL database corresponding to the configuration management platform. The sticker configuration information is stored in kconf (a configuration file) in the database corresponding to the configuration management platform. The sticker configuration information includes a sticker template. The sticker template includes at least one of a size, a color, a shape, a font, a font size, and the like of the preview sticker. The server acquires the first preview information and the sticker configuration information from the redis database and kconf, respectively.

In this embodiment of the present disclosure, the preview information and the sticker configuration information are respectively stored in the databases after being generated. In this way, the preview information and the sticker configuration information can be directly acquired from the databases subsequently, thereby improving the efficiency of acquiring the preview information and the sticker configuration information. Therefore, the efficiency of generating the preview sticker subsequently is improved.

In step 605, the server generates a first preview sticker based on the first preview information and the sticker configuration information.

The first preview information includes at least one of live streaming time, a live streaming theme, and a quantity of reservations. The sticker configuration information includes a sticker template. The server generates the first preview sticker based on the sticker template and at least one of the live streaming time, the live streaming theme, and the quantity of reservations. In some embodiments, the first preview sticker displays at least one of the live streaming time, the live streaming theme, the quantity of reservations, and the like. Arrangement positions of the live streaming time, the live streaming theme, the quantity of reservations, and the like in the first preview sticker can be specified and changed as required.

In this embodiment of the present disclosure, the preview sticker is generated based on the sticker template and the preview information such as the live streaming time, the live streaming theme, and the quantity of reservations, such that the preview sticker includes the preview information of the target live streaming for which a live preview is to be created. Therefore, the audience can directly acquire, from the preview sticker, the preview information of the target live streaming for which a live preview is to be created while the audience is watching the current live streaming in a live room. Therefore, the preview effect is improved.

It should be noted that, after generating the first preview sticker, the server stores information about the first preview sticker in the redis database, such that during subsequent determination on whether the content or status of the first preview sticker changes, fast comparison and determining can be performed based on the first preview sticker stored in the redis database. The content of the first preview sticker means the content of the preview information, such as the quantity of reservations and a live streaming theme, of the first preview sticker. The status of the first preview sticker means the first preview sticker being displayed in the live streaming interface, the first preview sticker being not displayed in the live streaming interface, or displaying the first preview sticker in the live streaming interface being canceled.

In other words, in the above steps 604 and 605, the server generates the first preview sticker in response to the sticker display request based on the first preview information corresponding to the live preview or based on the first preview information and the sticker configuration information.

In step 606, the server sends a sticker display instruction to a second terminal in the first live room.

The second terminal is a terminal used by an audience. The sticker display instruction carries the first preview sticker and is configured to instruct the second terminal to display the first preview sticker in a live streaming interface displayed by the second terminal.

In step 607, the second terminal receives the sticker display instruction sent by the server, and displays the first preview sticker in the live streaming interface of the first live room according to the sticker display instruction.

In some embodiments, the sticker display instruction is sent in the form of signaling. The signaling is a broadcast in the dimension of a live room. All second terminals in the first live room can receive the signaling. Each second terminal parses the content of the signaling, and displays the first preview sticker in the live streaming interface of the first live room based on the content of the first preview sticker being the signaling.

It should be noted that, a displaying position of the first preview sticker in the live streaming interface can be specified and changed as required. This is not limited in this embodiment of the present disclosure. In some embodiments, the sticker display instruction carries position information; and the first preview sticker is displayed in the live streaming interface based on the position information. In some embodiments, the first preview sticker is displayed in the live streaming interface based on the default position information. In some embodiments, the first preview sticker is displayed at any position at the bottom, the top, the left, or the right of the live streaming interface.

In some embodiments, the first terminal sends a cancel request to the server, wherein the cancel request is configured to request the server to send a sticker cancel instruction to the second terminal. The server receives the cancel request from the first terminal, and sends the sticker cancel instruction to the second terminal, wherein the sticker cancel instruction instructs the second terminal to cancel display of the first preview sticker. For example, the first terminal sends the cancel request to the server in response to the on/off status of the preview sticker control changing from an on state to an off state, namely, the on/off status of the preview sticker control being configured to indicate that displaying the preview sticker in the live streaming interface is not allowed, such that the server is enabled to send the sticker cancel instruction to the second terminal. In this embodiment of the present disclosure, a preview sticker which has been displayed in the second terminal can be canceled in time by sending the cancel request to the server. Therefore, flexibility of control over displaying of the preview sticker is improved.

In some embodiments, the server further sends the sticker display instruction to the first terminal in the first live room. The first terminal displays the first preview sticker in the live streaming interface in response to the sticker display instruction. In this embodiment of the present disclosure, the sticker display instruction is sent to the first terminal, such that the preview sticker can also be displayed in the live streaming interface of the first terminal. Therefore, the anchor can acquire, by the first terminal and based on the displayed preview sticker, information indicating whether the second terminal has displayed the preview sticker. Then, the anchor can perform the next adjusting operation in time based on the information indicating whether the preview sticker has been displayed.

According to the method for creating the live preview in this embodiment of the present disclosure, a preview sticker of live streaming can be created based on preview information and sticker configuration information of the live streaming when a live room is associated with a live preview, and the preview sticker can be displayed on a live streaming interface of a second terminal in a first live room. In this way, the audience can acquire the preview information of target live streaming when watching the current live streaming, such that the amount of information displayed in the live streaming interface and efficiency of outputting the information to the audience are improved. Therefore, the preview effect of the live preview is improved.

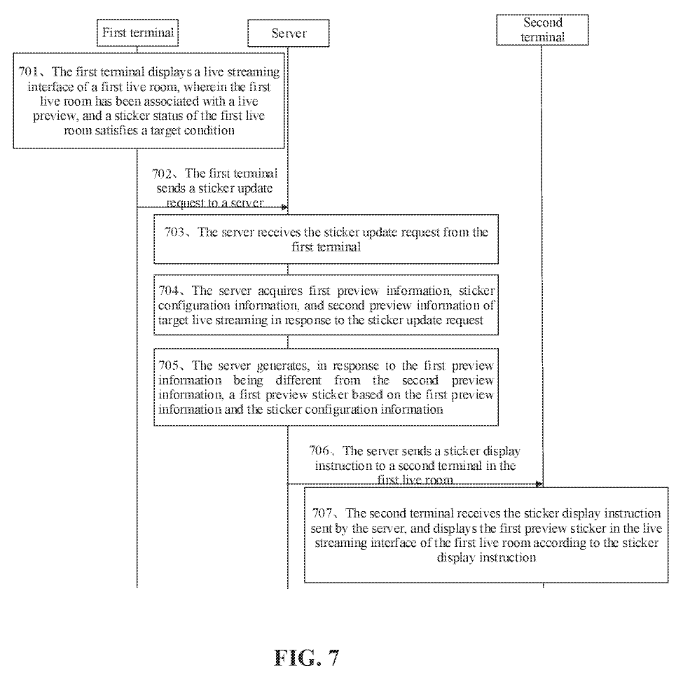

FIG. 7 is a flowchart of a method for creating a live preview according to some embodiments. The method includes the following steps to describe a process of updating a preview sticker.

In step 701, a first terminal displays a live streaming interface of a first live room, wherein the first live room has been associated with a live preview, and a sticker status of the first live room satisfies a target condition.

Step 701 is the same as step 601. Details are not described herein again.

In step 702, the first terminal sends a sticker update request to a server.

The sticker update request is configured to request displaying a preview sticker in the live streaming interface of the first live room. In some embodiments, the sticker update request is configured to request displaying an updated preview sticker in the live streaming interface of the first live room, namely, request updating a preview sticker currently displayed in the live streaming interface.

In step 703, the server receives the sticker update request from the first terminal.

In some embodiments, the server provides a sticker display function for the first live room in the case that the first live room of the first terminal has been associated with the live preview; and the first terminal is capable of triggering the sticker update request based on the sticker display function. In some embodiments, the server provides the sticker display function for the first live room in the case that the first live room of the first terminal has been associated with the live preview and the sticker status of the first live room satisfies the target condition. For example, the sticker display function is to periodically or continuously send sticker update requests by the first terminal to the server, such that the server can periodically or continuously acquire preview information in a subsequent process, thereby updating a preview sticker in time when the preview information changes.

A process in which the server determines whether the sticker status of the first live room satisfies the target condition is the same as step 603. Details are not described herein again.

In step 704, the server acquires first preview information, sticker configuration information, and second preview information of target live streaming in response to the sticker update request.

In this embodiment, the first preview information is the latest preview information; the second preview information is preview information corresponding to a second preview sticker which has been displayed in the first live room, and the preview information corresponding to the second preview sticker is preview information used when the second preview sticker is generated. In this step, a process of acquiring the first preview information and the sticker configuration information of the target live streaming by the server is the same as step 604. Details are not described herein again.

In some embodiments, the server acquires the second preview information from a first database, wherein the first database is configured to store preview information corresponding to a preview sticker which has been generated. In some embodiments, the first database is a redis database storing the second preview information. In this embodiment of the present disclosure, the preview information is stored in the database. In this way, the preview information can be directly acquired from the databases subsequently, thereby improving the efficiency of acquiring the preview information.

In step 705, the server generates, in response to the first preview information being different from the second preview information, a first preview sticker based on the first preview information and the sticker configuration information.

In some embodiments, the process is ended in the case that the first preview information is the same as the second preview information. Step 706 does not need to be performed.

In some embodiments, the live preview is provided with a reserve control configured to trigger reservation for the target live streaming. The server receives a reserve request from the second terminal, wherein the reserve request is sent in response to the reserve control being triggered; and updates preview information corresponding to the live preview in response to the reserve request. In some embodiments, the live preview is displayed in a preview sticker of the live room or in anchor’s homepage. Accordingly, reserve controls are disposed at both live preview positions of the live room and the anchor’s homepage.

The preview information includes a quantity of reservations. A quantity of people reserving the target live streaming increases after the reserve control is triggered. Therefore, the server changes the quantity of reservations in the preview information in response to the reserve request to acquire preview information having the updated quantity of reservations. It should be noted that, after the audience reserve the target live streaming, the server can send, before the target live streaming starts, start prompting information to a second terminal corresponding to the audience who want to watch the live streaming, that is, the server can provide a convenient prompting function for a user. In this embodiment of the present disclosure, the live preview is provided with the reserve control. In this way, a live room is additionally provided with a fixed reserving entry. In other words, the audience can reserve the target live streaming by triggering the reserve control. This provides a way for the audience to reserve live streaming to be watched. Therefore, views of the target live streaming can be increased.

In some embodiments, when a plurality of live rooms performing including the first live room are performing live streaming , the server uses a slicing task framework to respectively assign sticker update requests of a plurality of live rooms to a plurality of sticker update tasks, wherein each sticker update task is assigned a sticker update request of at least one live room; and a sticker update task corresponding to the first live room includes acquiring the second preview information in response to the sticker display request including a sticker update request, and generating, in response to the first preview information being different from the second preview information, the first preview sticker based on the first preview information and the sticker configuration information. For example, there are 100 sticker update tasks. If there are more than 100 live rooms, the live rooms are uniformly assigned to the 100 sticker update tasks for processing. For example, if there are 1000 live rooms, each sticker update task is assigned 10 live rooms.

In this embodiment of the present disclosure, because a large quantity of live rooms carry out live streaming simultaneously, a live streaming platform may have about hundreds of millions of daily active users. In this case, the slicing task framework is used to provide technical support for a plurality of live rooms, such that batch processing can be simultaneously, stably and efficiently performed on tasks for updating preview stickers of the plurality of live rooms. Therefore, the efficiency of updating preview stickers is improved.

In some embodiments, a process of executing the sticker update task corresponding to the first live room includes the following steps: first, querying for a preview associating status of the first live room; querying for the sticker status of the first live room in the case that the first live room has been associated with the live preview; querying for the first preview information, the sticker configuration information, and the second preview information based on a preview identifier of the target live streaming in the case that the sticker status of the live room satisfies the target condition; generating, in response to the first preview information being different from the second preview information, the first preview sticker based on the first preview information and the sticker configuration information; and sending a sticker display instruction to the second terminal, wherein the sticker display instruction is a sticker update instruction which instructs the second terminal to display the first preview sticker in the live streaming interface, thereby updating the currently displayed preview sticker or replacing the second preview sticker currently displayed in the second terminal with the first preview sticker.

In this embodiment of the present disclosure, when the preview information changes, the second terminal is instructed to update a currently displayed preview sticker to a preview sticker corresponding to the latest preview information, such that the preview sticker can change with the preview information in time. Further, the audience can acquire the latest preview information in time. Therefore, the accuracy of preview live streaming by using a preview sticker is improved.

In step 706, the server sends a sticker display instruction to a second terminal in the first live room.

In step 707, the second terminal receives the sticker display instruction sent by the server, and displays the first preview sticker in the live streaming interface of the first live room according to the sticker display instruction.

Steps 706 and 707 are the same as steps 606 and 607. Details are not described herein again.

In this embodiment of the present disclosure, a process of delivering a preview sticker and a process of updating a preview sticker are orchestrated rationally, such that information in a live room can synchronously change with a change of preview information by updating in time a preview sticker displayed in a second terminal. Further, the audience can acquire the latest preview information in time. Therefore, the accuracy of preview live streaming by using a preview sticker is improved.

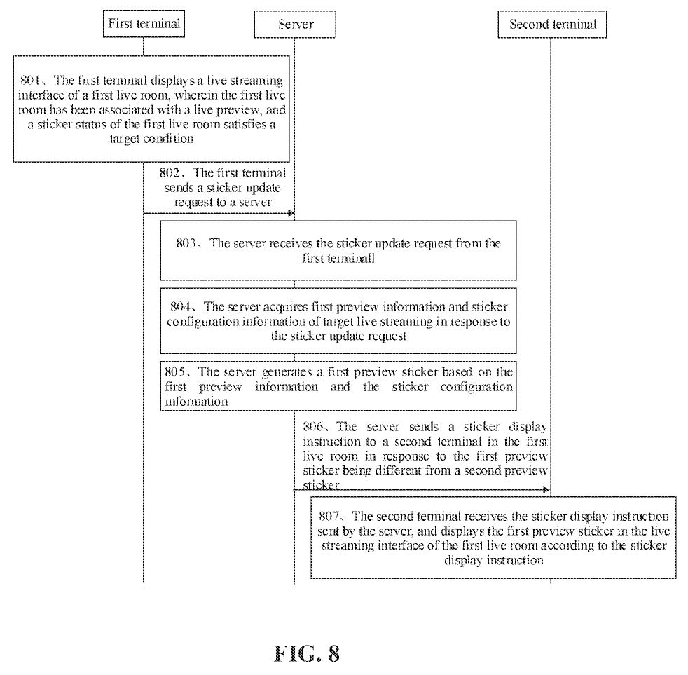

FIG. 8 is a flowchart of a method for creating a live preview according to some embodiments. The method includes the following steps to describe a process of updating a preview sticker.

In step 801, a first terminal displays a live streaming interface of a first live room, wherein the first live room has been associated with a live preview, and a sticker status of the first live room satisfies a target condition.

In step 802, the first terminal sends a sticker update request to a server.

In step 803, the server receives the sticker update request from the first terminal.

Steps 801 to 803 are the same as steps 701 to 703. Details are not described herein again.

In step 804, the server acquires first preview information and sticker configuration information of target live streaming in response to the sticker update request.

Step 804 is the same as a process of acquiring the first preview information and the sticker configuration information by the server in step 604. Details are not described herein again.

In step 805, the server generates a first preview sticker based on the first preview information and the sticker configuration information.

Step 805 is the same as step 605. Details are not described herein again.

In step 806, the server sends a sticker display instruction to a second terminal in the first live room in response to the first preview sticker being different from a second preview sticker.

The second preview sticker is a preview sticker currently displayed in the second terminal. In some embodiments, the server acquires the second preview sticker from a redis database. The redis database is configured to store a preview sticker which has been generated. Therefore, a displayed preview sticker can be queried fast and conveniently when it is determined subsequently that a status of the displayed preview sticker is changed.

In some embodiments, when the first preview sticker is the same as the second preview sticker, the server ends the process and does not send the sticker display instruction to the second terminal.

In some embodiments, the server periodically or continuously receives sticker update requests, thereby acquiring the latest preview information, and generating a preview sticker corresponding to the latest preview information. In this way, preview stickers are constantly generated based on the latest preview information, such that when a preview sticker corresponding to the latest preview information is different from a preview sticker currently displayed in the second terminal, the second terminal is directly instructed to update the currently displayed preview sticker to the latest preview sticker. This operation is convenient.

In some embodiments, when a plurality of live rooms including the first live room are performing live streaming simultaneously, the server uses a slicing task framework to respectively assign sticker update requests of a plurality of live rooms to a plurality of sticker update tasks, wherein each sticker update task is assigned a sticker update request of at least one live room; and a sticker update task corresponding to the first live room is to acquire the first preview information and the sticker configuration information, generate the first preview sticker based on the first preview information and the sticker configuration information, and send the sticker display instruction to the second terminal in the first live room in response to the first preview sticker being different from the second preview sticker.

A process of executing the sticker update task corresponding to the first live room includes the following steps: first, querying for a preview associating status of the first live room; querying for the sticker status of the first live room in the case that the first live room has been associated with the live preview; querying for the first preview information, the sticker configuration information, and the second preview sticker based on a preview identifier of the target live streaming in the case that the sticker status of the live room satisfies the target condition; generating the first preview sticker based on the first preview information and the sticker configuration information; and sending the sticker display instruction by the server to the second terminal in the first live room, wherein the sticker display instruction is a sticker update instruction which instructs the second terminal to display the first preview sticker in the live streaming interface, thereby updating the second preview sticker currently displayed in the second terminal to the first preview sticker.

In this step, a process of sending the sticker display instruction by the server to the second terminal is the same as that in step 706. Details are not described herein again.

In step 807, the second terminal receives the sticker display instruction sent by the server, and displays the first preview sticker in the live streaming interface of the first live room according to the sticker display instruction.

Step 807 is the same as step 707. Details are not described herein again.

In this embodiment of the present disclosure, a process of delivering a preview sticker and a process of updating a preview sticker are orchestrated rationally, such that information in a live room can synchronously change with a change of preview information by updating in time a preview sticker displayed in a second terminal. Further, the audience can acquire the latest preview information in time. Therefore, the accuracy of preview live streaming by using a preview sticker is improved.

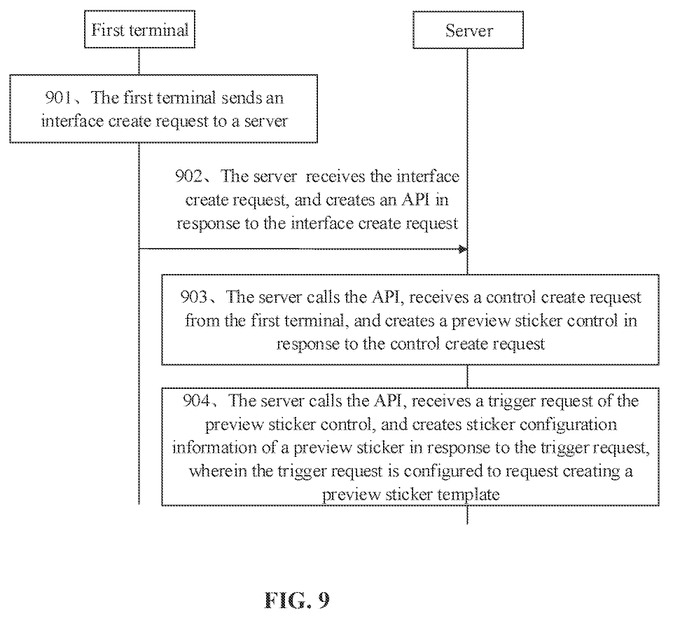

FIG. 9 is a flowchart of a method for creating a live preview according to some embodiments. The method for creating the live preview is executed by a server. As shown in FIG. 9, the method includes the following steps.

In step 901, a first terminal sends an interface create request to the server.

The interface create request is configured to request the server to create an API for a preview sticker control. The API is configured to implement information transmission between the first terminal and the server.

In step 902, the server receives the interface create request, and creates an API in response to the interface create request.

In some embodiments, after creating the API, the server may further update the API according to an interface update request from the first terminal.

In step 903, the server calls the API, receives a control create request from the first terminal, and creates a preview sticker control in response to the control create request.

The control create request is configured to request creating a preview sticker control of a first live room of the first terminal. In some embodiments, the server creates the preview sticker control in a live preview panel of a live streaming application. It should be noted that, the live preview panel is configured to generate a live preview corresponding to target live streaming. The live preview includes preview information. The live preview panel further includes at least one of a time selecting control, a text inputting control, and the like. The time selecting control is configured to select live streaming time for the target live streaming. The text inputting control is configured to input a live streaming theme of the target live streaming. On/off status of the preview sticker control includes an on state and an off state. The on/off status of the preview sticker control indicates whether displaying a preview sticker in a live streaming interface is allowed. In some embodiments, the on/off status of the preview sticker control is the off state by default, that is, displaying the preview sticker in the live streaming interface is not allowed by default.

In step 904, the server calls the API, receives a trigger request of the preview sticker control, and creates sticker configuration information of a preview sticker in response to the trigger request, wherein the trigger request is configured to request creating a preview sticker template.

In some embodiments, the server calls the API to determine whether the preview sticker control is triggered for the first time; and creates the sticker configuration information of the preview sticker in response to the preview sticker control being triggered for the first time. It should be noted that, the preview sticker is a preview sticker of target live streaming for which a live preview is to be created based on the live preview panel. In some embodiments, the server stores the created sticker configuration information in a MySQL database, such that the sticker configuration information can be directly acquired from the database for subsequently generating the preview sticker. Therefore, the efficiency of generating the preview sticker can be improved. In some embodiments, the server calls the API to determine whether the preview sticker control is triggered for the first time; determines that the trigger request of the preview sticker control is a configuration update request in response to the preview sticker control being not triggered for the first time, wherein the configuration update request is configured to request updating the on/off status of the preview sticker control; and updates the on/off status of the preview sticker control according to the configuration update request.

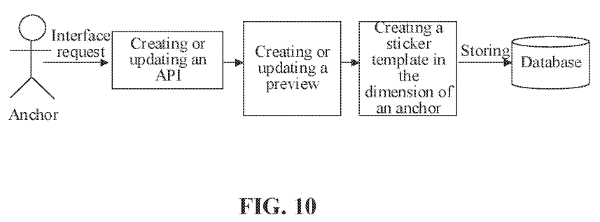

Referring to FIG. 10, an anchor triggers a first terminal to send an interface request to a server, wherein the interface request is an interface create request or an interface update request; and the server creates or updates an API according to the interface request. The server calls the API to determine whether the trigger request of the preview sticker control requests creating a preview sticker template or updating the preview sticker control. If it is determined through the API that the trigger request of the preview sticker control requests creating the preview sticker template, the server creates a sticker template of a preview sticker in the dimension of an anchor, and stores the sticker template in a MySQL database.

In this embodiment of the present disclosure, the API is created for the preview sticker control, such that information about the preview sticker control can be transmitted between the first terminal and the server. Therefore, data transmission efficiency is improved; and the server is enabled to update on/off configuration of the preview sticker control in time by responding to the on/off status of the preview sticker control in time.

It should be noted that, the association between preview information and a first live room or an anchor can be enhanced by displaying preview information of live streaming in a live room according to the method in this embodiment of the present disclosure, such that the anchor can create an interactive topic in the live room based on the preview information displayed in the preview sticker. In addition, displaying of stable preview information can help the anchor and audience enhance their perception and expectation of a live preview. Therefore, the duration by which the audience watches the live streaming is prolonged. The preview information further provides a reserving function which is implemented by adding a fixed reserving entry in the first live room for the live streaming for which a live preview is to be created, such that the anchor can lead, through oral broadcasting, the audience to make a reservation. Therefore, a tool is provided for the anchor to actively carry out live streaming; and an efficient way is provided for the audience to watch the live streaming.

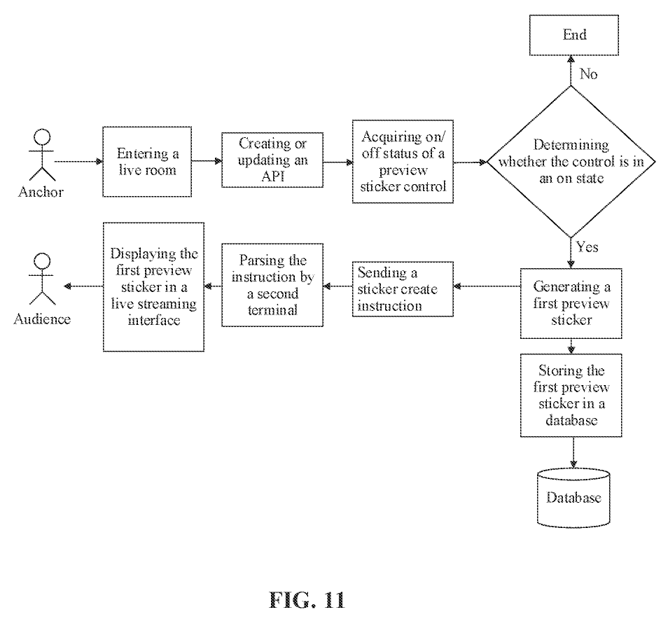

An embodiment of the present disclosure further provides a method for reserving live streaming. Referring to FIG. 11, an anchor performs operations on a first terminal, such that a live streaming application of the first terminal enters a live room, and an interface of the live streaming application displays a live streaming interface of a first live room. The first terminal sends an interface create request to a server. The server creates an API for a preview sticker control according to the interface create request; acquires on/off status of the preview sticker control through the API of the preview sticker control; and if the preview sticker control is in an off state, ends the process; or if the preview sticker control is in an on state, generates a first preview sticker, stores the first preview sticker in a redis database, and sends a sticker display instruction to a second terminal. The second terminal parses the sticker display instruction to acquire the first preview sticker carried in the sticker display instruction, and displays the first preview sticker in the live streaming interface of the live room, such that the audience, while watching a live streaming, can acquire and see preview information of target live streaming for which a live preview is to be created.

According to the method for creating a live preview in this embodiment of the present disclosure, a preview sticker of live streaming can be generated based on preview information and sticker configuration information of the live streaming; and the preview sticker can be displayed on a live streaming interface of a second terminal in a first live room. In this way, the audience can acquire the preview information of the target live streaming when watching the live streaming, such that an amount of information displayed in the live streaming interface and efficiency of outputting the information to the audience are improved. Therefore, a preview effect of a live preview is improved.

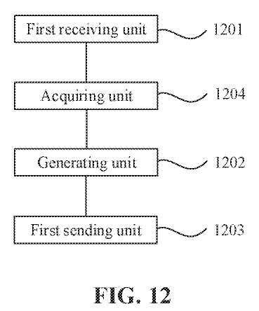

FIG. 12 is a block diagram of an apparatus for creating a live preview according to some embodiments. Referring to FIG. 12, the apparatus includes:
a first receiving unit 1201 configured to receive a sticker display request from a first terminal, wherein a first live room of the first terminal has been associated with a live preview, the first terminal being a terminal used by an anchor;
a generating unit 1202 configured to generate, in response to the sticker display request, a first preview sticker based on first preview information corresponding to the live preview; and
a first sending unit 1203 configured to send a sticker display instruction to a second terminal in the first live room, wherein the sticker display instruction carries the first preview sticker, and instructs the second terminal to display the first preview sticker in a live streaming interface of the first live room, the second terminal being a terminal used by an audience.

The apparatus further includes:
an acquiring unit 1204 configured to acquire the first preview information and sticker configuration information in response to the sticker display request; and
the generating unit 1202 is configured to generate the first preview sticker based on the first preview information and the sticker configuration information.

In some embodiments, the generating unit 1202 is configured to generate, in response to the sticker display request including a sticker create request, the first preview sticker based on the first preview information and the sticker configuration information.

In some embodiments, the generating unit 1202 includes:
an acquiring sub-unit configured to acquire second preview information in response to the sticker display request including a sticker update request, wherein the second preview information is preview information corresponding to a second preview sticker which has been displayed in the first live room; and
a generating sub-unit configured to generate, in response to the first preview information being different from the second preview information, the first preview sticker based on the first preview information and the sticker configuration information.

In some embodiments, there are a plurality of live rooms performing live streaming simultaneously with the first live room; and the apparatus further includes:

an assigning unit configured to respectively assign sticker update requests of a plurality of live rooms to a plurality of sticker update tasks, wherein each sticker update task is assigned a sticker update request of at least one live room; and a sticker update task corresponding to the first live room includes acquiring the second preview information in response to the sticker display request including a sticker update request, and generating, in response to the first preview information being different from the second preview information, the first preview sticker based on the first preview information and the sticker configuration information.

In some embodiments, the acquiring sub-unit is configured to acquire the second preview information from a first database, wherein the first database is configured to store preview information corresponding to a preview sticker which has been generated.

In some embodiments, the acquiring unit 1204 is configured to acquire the sticker configuration information from a second database, wherein the second database is a database corresponding to a configuration management platform.

In some embodiments, the live preview is provided with a reserve control configured to trigger reservation for the target live streaming; and the apparatus further includes:
a second receiving unit configured to receive a reserve request from the second terminal, wherein the reserve request is sent in response to the reserve control being triggered; and
a first updating unit configured to update preview information corresponding to the live preview in response to the reserve request.

In some embodiments, the apparatus further includes:

a third receiving unit configured to receive a cancel request from the first terminal, and send a sticker cancel instruction to the second terminal, wherein the sticker cancel instruction instructs the second terminal to cancel display of the first preview sticker.

In some embodiments, the first preview information includes at least one of live streaming time, a live streaming theme, or a quantity of reservations; the sticker configuration information includes a sticker template; and

the generating unit 1202 is configured to generate the first preview sticker based on the sticker template and at least one of the live streaming time, the live streaming theme, or the quantity of reservations.

In some embodiments, the first receiving unit 1201 is configured to provide a sticker display function for the first live room in the case that the first live room of the first terminal has been associated with the live preview, wherein the first terminal is capable of triggering the sticker display request based on the sticker display function.

In some embodiments, the first receiving unit 1201 is configured to provide the sticker display function for the first live room in the case that the first live room of the first terminal has been associated with the live preview and a sticker status of the first live room satisfies a target condition.

In some embodiments, the first receiving unit 1201 includes:
a querying sub-unit configured to query for on/off status of a preview sticker control of the first live room, wherein the on/off status indicates whether displaying a preview sticker in the live streaming interface is allowed;
a first determining sub-unit configured to determine that the sticker status satisfies the target condition in the case that the on/off status indicates that displaying the preview sticker in the live streaming interface is allowed; and
a second determining sub-unit configured to determine that the sticker status does not satisfy the target condition in the case that the on/off status indicates that displaying the preview sticker in the live streaming interface is not allowed.

In some embodiments, the apparatus for creating a live preview further includes:
a fourth receiving unit configured to receive a configuration update request from the first terminal, wherein the configuration update request is triggered based on the preview sticker control of the first live room; and
a second updating unit configured to update the on/off status of the preview sticker control in response to the configuration update request.

In some embodiments, the apparatus further includes:
a fifth receiving unit configured to receive a control create request from the first terminal; and
a creating unit configured to create the preview sticker control in response to the control create request.

In some embodiments, the querying sub-unit is configured to: call an API corresponding to the preview sticker control, and query for the on/off status of the preview sticker control.

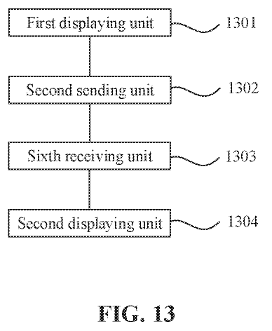

FIG. 13 is a block diagram of an apparatus for creating a live preview according to some embodiments. Referring to FIG. 13, the apparatus includes:
a first displaying unit 1301 configured to display a live streaming interface of a first live room, wherein the first live room has been associated with a live preview;
a second sending unit 1302 configured to send a sticker display request to a server;
a sixth receiving unit 1303 configured to receive a sticker display instruction from the server, wherein the sticker display instruction carries a first preview sticker which is generated by the server in response to the sticker display request based on first preview information corresponding to the live preview; and
a second displaying unit 1304 configured to display the first preview sticker in the live streaming interface in response to the sticker display instruction.

In some embodiments, the first preview sticker is also displayed in a live streaming interface of a second terminal in the first live room; the second terminal is a terminal used by audience; and the apparatus further includes:

a third sending unit configured to send a cancel request to the server, wherein the cancel request is configured to request the server to send a sticker cancel instruction to the second terminal; and the sticker cancel instruction instructs the second terminal to cancel display of the first preview sticker.

In some embodiments, the sticker display request is sent in the case that a sticker status of the first live room satisfies a target condition; the sticker status satisfying the target condition means that on/off status of a preview sticker control of the first live room indicates that displaying a preview sticker in the live streaming interface is allowed; and the apparatus further includes:
a fourth sending unit configured to send a configuration update request to the server, wherein the configuration update request is triggered based on the preview sticker control of the first live room; and
a seventh receiving unit configured to receive updated on/off status of the preview sticker control from the server, wherein the updated on/off status is acquired by updating the on/off status of the preview sticker control by the server in response to the configuration update request.

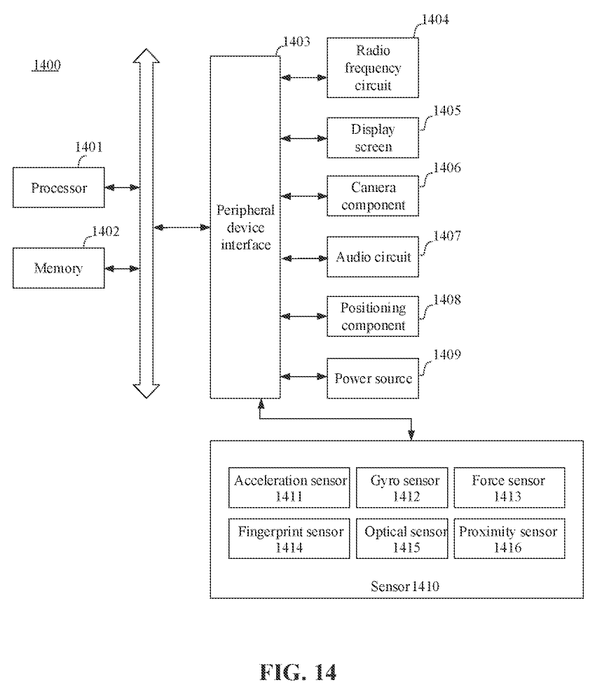

FIG. 14 is a structural block diagram of a terminal 1400 according to some embodiments of the present disclosure. The terminal 1400 may be a portable mobile terminal, for example, a smart mobile phone, a tablet computer, a moving picture experts group audio layer III (MP3) player, a moving picture experts group audio layer IV (MP4) player, a notebook computer, or a desktop computer. The terminal 1400 may also be called user equipment (UE), a portable terminal, a laptop terminal, a desktop terminal, or the like.

Generally, the terminal 1400 includes: a processor 1401 and a memory 1402.

The processor 1401 may include one or more processing cores, such as a 4-core processor and an 8-core processor. The processor 1401 may be formed by at least one hardware of a digital signal processing (DSP), a field-programmable gate array (FPGA), and a programmable logic array (PLA). The processor 1401 may also include a main processor and a coprocessor. The main processor is a processor for processing data in an awake state, and is also called a central processing unit (CPU). The coprocessor is a low-power-consumption processor for processing the data in a standby state. In some embodiments, the processor 1401 may be integrated with a graphics processing unit (GPU) configured to be responsible for rendering and drawing content that needs to be displayed by a display screen. In some embodiments, the processor 1401 may further include an artificial intelligence (AI) processor configured to process computing operations related to machine learning.

The memory 1402 may include one or more computer-readable storage media, which may be non-transitory. The memory 1402 may further include a high-speed random access memory, as well as a non-volatile memory, such as one or more disk storage devices and flash storage devices. In some embodiments, the non-transitory computer-readable storage medium in the memory 1402 is configured to store at least one program code. The at least one program code is executed by the processor 1401 to implement the method for creating the live preview provided in the method embodiments of the present disclosure.

In some embodiments, optionally, the terminal 1400 may further include: a peripheral device interface 1403 and at least one peripheral device. The processor 1401, the memory 1402, and the peripheral device interface 1403 may be connected via a bus or a signal line. Each peripheral device may be connected to the peripheral device interface 1403 via a bus, a signal line, or a circuit board. Specifically, the peripheral device includes: at least one of a radio frequency circuit 1404, a display screen 1405, a camera component 1406, an audio circuit 1407, a positioning component 1408, and a power source 1409.

The peripheral device interface 1403 may be configured to connect at least one peripheral device associated with an input/output (I/O) to the processor 1401 and the memory 1402. In some embodiments, the processor 1401, the memory 1402, and the peripheral device interface 1403 are integrated on the same chip or circuit board. In some other embodiments, any one or two of the processor 1401, the memory 1402, and the peripheral device interface 1403 are implemented on a separate chip or circuit board, which is not limited in this embodiment of the present disclosure.

The radio frequency circuit 1404 is configured to receive and transmit a radio frequency (RF) signal, which is also referred to as an electromagnetic signal. The radio frequency circuit 1404 communicates with a communication network and other communication devices via the electromagnetic signal. The radio frequency circuit 1404 converts the electrical signal into the electromagnetic signal for transmission, or converts the received electromagnetic signal into the electrical signal. Optionally, the radio frequency circuit 1404 includes: an antenna system, an RF transceiver, one or more amplifiers, a tuner, an oscillator, a digital signal processor, a codec chipset, a subscriber identity module card, and the like. The radio frequency circuit 1404 may communicate with other terminals via at least one wireless communication protocol. The wireless communication protocol includes, but is not limited to: the World Wide Web, a metropolitan area network, an intranet, various generations of mobile communication networks (2G, 3G, 4G, and 5G), a wireless local area network, and/or a wireless fidelity (WiFi) network. In some embodiments, the radio frequency circuit 1404 may further include near field communication (NFC) related circuits, which is not limited in the present disclosure.

The display screen 1405 is configured to display a user interface (UI). The UI may include graphics, text, icons, videos, and any combination thereof. When the display screen 1405 is a touch display screen, the display screen 1405 also has the capacity to acquire a touch signal on or over the surface of the display screen 1405. The touch signal may be input into the processor 1401 as a control signal for processing. In this case, the display screen 1405 may also be configured to provide virtual buttons and/or virtual keyboards, which are also referred to as soft buttons and/or soft keyboards. In some embodiments, there may be one display screen 1405 disposed on a front panel of the terminal 1400. In some other embodiments, there may be at least two display screens 1405 disposed on different surfaces of the terminal 1400 respectively or in a folded design. In some other embodiments, the display screen 1405 may be a flexible display screen disposed on a curved or folded surface of the terminal 1400. Even the display screen 1405 may have an irregular shape other than a rectangle, that is, the display screen 1405 may be an irregular-shaped screen. The display screen 1405 may be a light crystal display (LCD) screen, an organic light-emitting diode (OLED) display screen, or the like.

The camera component 1406 is configured to acquire images or videos. Optionally, the camera component 1406 includes a front camera and a rear camera. Usually, the front camera is disposed on the front panel of the terminal, and the rear camera is disposed on the back of the terminal. In some embodiments, there are at least two rear cameras, each of which is any one of a main camera, a depth-of-field camera, a wide-angle camera, and a telephoto camera, to implement a background blurring function by fusing the main camera and the depth-of-field camera, panoramic shooting and virtual reality (VR) shooting functions by fusing the main camera and the wide-angle camera, or another fusion-based shooting function. In some embodiments, the camera component 1406 may further include a flashlight. The flashlight may be a mono-color-temperature flashlight or a two-color-temperature flashlight. The two-color-temperature flashlight is a combination of a warm flashlight and a cold flashlight and can be used for light compensation at different color temperatures.

The audio circuit 1407 may include a microphone and a speaker. The microphone is configured to acquire sound waves of users and environments, and convert the sound waves into electrical signals which are input into the processor 1401 for processing or input into the radio frequency circuit 1404 for voice communication. For the purpose of stereo acquisition or noise reduction, there may be a plurality of microphones respectively disposed at different positions of the terminal 1400. The microphone may also be an array microphone or an omnidirectional acquisition microphone. The speaker is configured to convert the electrical signal from the processor 1401 or the radio frequency circuit 1404 into the sound waves. The speaker may be a conventional film speaker or a piezoelectric ceramic speaker. When the speaker is the piezoelectric ceramic speaker, the electrical signal can be converted into not only human-audible sound waves but also sound waves which are inaudible to humans for the purpose of ranging and the like. In some embodiments, the audio circuit 1407 may further include a headphone jack.

The positioning component 1408 is configured to locate the current geographic location of the terminal 1400 to implement navigation or a location-based service (LBS). The positioning component 1408 may be the United States’ Global Positioning System (GPS), Russia’s Global Navigation Satellite System (GLONASS), China’s BeiDou Navigation Satellite System (BDS), and the European Union’s Galileo.

The power source 1409 is configured to power up various components in the terminal 1400. The power source 1409 may be alternating current, direct current, a disposable battery, or a rechargeable battery. When the power source 1409 includes the rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charge technology.

In some embodiments, the terminal 1400 further includes one or more sensors 1410. The one or more sensors 1410 include, but are not limited to, an acceleration sensor 1411, a gyro sensor 1412, a force sensor 1413, a fingerprint sensor 1414, an optical sensor 1415, and a proximity sensor 1416.

The acceleration sensor 1411 may detect magnitudes of accelerations on three coordinate axes of a coordinate system established by the terminal 1400. For example, the acceleration sensor 1411 may be configured to detect components of a gravitational acceleration on the three coordinate axes. The processor 1401 may control the display screen 1405 to display a user interface in a landscape view or a portrait view according to a gravity acceleration signal acquired by the acceleration sensor 1411. The acceleration sensor 1411 may also be configured to acquire motion data of a game or a user.

The gyro sensor 1412 can detect a body direction and a rotation angle of the terminal 1400, and can cooperate with the acceleration sensor 1411 to acquire a 3D motion of the user on the terminal 1400. Based on data acquired by the gyro sensor 1412, the processor 1401 can implement the following functions: motion sensing (such as changing the UI according to a tilt operation of the user), image stabilization during shooting, game control, and inertial navigation.

The force sensor 1413 may be disposed on a side frame of the terminal 1400 and/or a lower layer of the display screen 1405. When the force sensor 1413 is disposed on the side frame of the terminal 1400, a user’s holding signal to the terminal 1400 can be detected. The processor 1401 can perform left-right hand recognition or quick operation according to the holding signal acquired by the force sensor 1413. When the force sensor 1413 is disposed on the lower layer of the display screen 1405, the processor 1401 controls an operable control on the UI according to a user’s force operation on the display screen 1405. The operable control includes at least one of a button control, a scroll bar control, an icon control, and a menu control.

The fingerprint sensor 1414 is configured to acquire a user’s fingerprint. The processor 1401 identifies the user’s identity based on the fingerprint acquired by the fingerprint sensor 1414, or the fingerprint sensor 1414 identifies the user’s identity based on the acquired fingerprint. When the user’s identity is identified as trusted, the processor 1401 authorizes the user to perform related sensitive operations, such as unlocking the screen, viewing encrypted information, downloading software, paying, and changing settings. The fingerprint sensor 1414 may be disposed on the front, the back, or a side of the terminal 1400. When the terminal 1400 is provided with a physical button or a manufacturer’s Logo, the fingerprint sensor 1414 may be integrated with the physical button or the manufacturer’s Logo.

The optical sensor 1415 is configured to acquire ambient light intensity. In an embodiment, the processor 1401 may control the display brightness of the display screen 1405 according to the ambient light intensity acquired by the optical sensor 1415. Specifically, when the ambient light intensity is high, the display brightness of the display screen 1405 is increased; and when the ambient light intensity is low, the display brightness of the display screen 1405 is decreased. In another embodiment, the processor 1401 may also dynamically adjust shooting parameters of the camera component 1406 according to the ambient light intensity acquired by the optical sensor 1415.

The proximity sensor 1416, also referred to as a distance sensor, is usually disposed on the front panel of the terminal 1400. The proximity sensor 1416 is configured to capture a distance between the user and the front of the terminal 1400. In an embodiment, when the proximity sensor 1416 detects that the distance between the user and the front surface of the terminal 1400 gradually decreases, the processor 1401 controls the display screen 1405 to switch from a screen-on state to a screen-off state. When the proximity sensor 1416 detects that the distance between the user and the front surface of the terminal 1400 gradually increases, the processor 1401 controls the display screen 1405 to switch from the screen-off state to the screen-on state.

Those skilled in the art may understand that the structure shown in FIG. 14 does not constitute a limitation to the terminal 1400. The terminal may include more or fewer components than those shown in the figure, or some components may be combined, or a different component deployment may be used.

Some embodiments of the present disclosure provide an electronic device. The electronic device includes: one or more processors; and a memory configured to store one or more instructions executable by the one or more processors, wherein the one or more processors, when loading and executing the one or more instructions, are caused to perform:
displaying a live streaming interface of a first live room, wherein the first live room has been associated with a live preview;
sending a sticker display request to a server;
receiving a sticker display instruction from the server, wherein the sticker display instruction carries a first preview sticker which is generated, in response to the sticker display request, by the server based on first preview information corresponding to the live preview; and
displaying the first preview sticker in the live streaming interface in response to the sticker display instruction.

In some embodiments, the first preview sticker is also displayed in a live streaming interface of a second terminal in the first live room; the second terminal is a terminal used by an audience; and the one or more processors, when loading and executing the one or more instructions, are caused to perform:

sending a cancel request to the server, wherein the cancel request is configured to request the server to send a sticker cancel instruction to the second terminal; and the sticker cancel instruction instructs the second terminal to cancel display of the first preview sticker.

In some embodiments, the sticker display request is sent in the case that a sticker status of the first live room satisfies a target condition; the sticker status satisfying the target condition means that on/off status of a preview sticker control of the first live room indicates that displaying a preview sticker in the live streaming interface is allowed; and the one or more processors, when loading and executing the one or more instructions, are caused to perform:
sending a configuration update request to the server, wherein the configuration update request is triggered based on the preview sticker control; and
receiving updated on/off status of the preview sticker control from the server, wherein the updated on/off status is acquired by updating the on/off status of the preview sticker control by the server in response to the configuration update request.

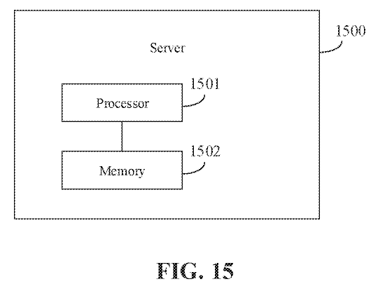

FIG. 15 is a schematic structural diagram of a server according to some embodiments of the present disclosure. The server 1500 may vary greatly due to different configurations or performance and includes at least one central processing unit (CPU) 1501 and at least one memory 1502, wherein the memory 1502 stores at least one program code, and the at least one program code is loaded and executed by the processor 1501 to implement the method for creating the live preview provided in the above method embodiments. Certainly, the server may further include components such as a wired or wireless network interface, a keyboard, and an input/output interface, for input and output. The server may further include other components for implementing functions of a device, which are not described herein.

Some embodiments of the present disclosure provide an electronic device. The electronic device includes: one or more processors; and a memory configured to store one or more instructions executable by the one or more processors, wherein the one or more processors, when loading and executing the one or more instructions, are caused to perform:

receiving a sticker display request from a first terminal, wherein a first live room of the first terminal has been associated with a live preview, the first terminal being a terminal used by an anchor;
generating, in response to the sticker display request, a first preview sticker based on first preview information corresponding to the live preview; and
sending a sticker display instruction to a second terminal in the first live room, wherein the sticker display instruction carries the first preview sticker, and instructs the second terminal to display the first preview sticker in a live streaming interface of the first live room, the second terminal being a terminal used by an audience.

In some embodiments, the one or more processors, when loading and executing the one or more instructions, are caused to perform:
acquiring the first preview information and sticker configuration information in response to the sticker display request; and
generating the first preview sticker based on the first preview information and the sticker configuration information.

In some embodiments, the one or more processors, when loading and executing the one or more instructions, are caused to perform:

generating, in response to the sticker display request including a sticker create request, the first preview sticker based on the first preview information and the sticker configuration information.

In some embodiments, the one or more processors, when loading and executing the one or more instructions, are caused to perform:
acquiring second preview information in response to the sticker display request including a sticker update request, wherein the second preview information is preview information corresponding to a second preview sticker which has been displayed in the first live room; and
generating, in response to the first preview information being different from the second preview information, the first preview sticker based on the first preview information and the sticker configuration information.

In some embodiments, there are a plurality of live rooms performing live streaming simultaneously with the first live room; and the one or more processors, when loading and executing the one or more instructions, are caused to perform:
respectively assigning sticker update requests of a plurality of live rooms to a plurality of sticker update tasks, wherein each sticker update task is assigned a sticker update request of at least one live room, and a sticker update task corresponding to the first live room includes acquiring the second preview information in response to the sticker display request including a sticker update request, and generating, in response to the first preview information being different from the second preview information, the first preview sticker based on the first preview information and the sticker configuration information.

In some embodiments, the one or more processors, when loading and executing the one or more instructions, are caused to perform:

acquiring the second preview information from a first database, wherein the first database is configured to store preview information corresponding to a preview sticker which has been generated.

In some embodiments, the one or more processors, when loading and executing the one or more instructions, are caused to perform:

acquiring the sticker configuration information from a second database, wherein the second database is a database corresponding to a configuration management platform.

In some embodiments, the live preview is provided with a reserve control configured to trigger reservation for the target live streaming; and the one or more processors, when loading and executing the one or more instructions, are caused to perform:
receiving a reserve request from the second terminal, wherein the reserve request is sent in response to the reserve control being triggered; and
updating preview information corresponding to the live preview in response to the reserve request.

In some embodiments, the one or more processors, when loading and executing the one or more instructions, are caused to perform:

receiving a cancel request from the first terminal, and sending a sticker cancel instruction to the second terminal, wherein the sticker cancel instruction instructs the second terminal to cancel display of the first preview sticker.

In some embodiments, the first preview information includes at least one of live streaming time, a live streaming theme, and a quantity of reservations; the sticker configuration information includes a sticker template; and the one or more processors, when loading and executing the one or more instructions, are caused to perform:

generating the first preview sticker based on the sticker template and at least one of the live streaming time, the live streaming theme, or the quantity of reservations.

In some embodiments, the one or more processors, when loading and executing the one or more instructions, are caused to perform:

providing a sticker display function for the first live room in the case that the first live room of the first terminal has been associated with the live preview, wherein the first terminal is capable of triggering the sticker display request based on the sticker display function.

In some embodiments, the one or more processors, when loading and executing the one or more instructions, are caused to perform:

providing the sticker display function for the first live room in the case that the first live room of the first terminal has been associated with the live preview and a sticker status of the first live room satisfies a target condition.

In some embodiments, the one or more processors, when loading and executing the one or more instructions, are caused to perform:
querying for on/off status of a preview sticker control of the first live room, wherein the on/off status indicates whether displaying a preview sticker in the live streaming interface is allowed; and
determining that the sticker status satisfies the target condition in the case that the on/off status indicates that displaying the preview sticker in the live streaming interface is allowed; or
determining that the sticker status does not satisfy the target condition in the case that the on/off status indicates that displaying the preview sticker in the live streaming interface is not allowed.

In some embodiments, the one or more processors, when loading and executing the one or more instructions, are caused to perform:
receiving a configuration update request from the first terminal, wherein the configuration update request is triggered based on the preview sticker control of the first live room; and
updating the on/off status of the preview sticker control in response to the configuration update request.

In some embodiments, the one or more processors, when loading and executing the one or more instructions, are caused to perform:
receiving a control create request from the first terminal; and
creating the preview sticker control in response to the control create request.

In some embodiments, the one or more processors, when loading and executing the one or more instructions, are caused to perform:

calling an API corresponding to the preview sticker control, and querying for the on/off status of the preview sticker control.

In some embodiments, there is also provided a non-transitory computer-readable storage medium, such as a memory including an instruction. The instruction can be executed by a processor in an electronic device to implement the method for creating a live preview according to the above embodiments. For example, the computer-readable storage medium may be a ROM, a RAM, a CD-ROM, a magnetic tape, a floppy disk, an optical data storage device, or the like.

Some embodiments of the present disclosure provide a non-transitory computer-readable storage medium storing one or more instructions therein. The one or more instructions, when loaded and executed by a processor of an electronic device, cause the electronic device to perform:
receiving a sticker display request from a first terminal, wherein a first live room of the first terminal has been associated with a live preview, the first terminal being a terminal used by an anchor;
generating, in response to the sticker display request, a first preview sticker based on first preview information corresponding to the live preview; and
sending a sticker display instruction to a second terminal in the first live room, wherein the sticker display instruction carries the first preview sticker, and instructs the second terminal to display the first preview sticker in a live streaming interface of the first live room, the second terminal being a terminal used by an audience.

In some embodiments, the one or more instructions, when loaded and executed by the processor of the electronic device, cause the electronic device to perform:
acquiring the first preview information and sticker configuration information in response to the sticker display request; and
generating the first preview sticker based on the first preview information and the sticker configuration information.

In some embodiments, the one or more instructions, when loaded and executed by the processor of the electronic device, cause the electronic device to perform:

generating, in response to the sticker display request including a sticker create request, the first preview sticker based on the first preview information and the sticker configuration information.

In some embodiments, the one or more instructions, when loaded and executed by the processor of the electronic device, cause the electronic device to perform:
acquiring second preview information in response to the sticker display request including a sticker update request, wherein the second preview information is preview information corresponding to a second preview sticker which has been displayed in the first live room; and
generating, in response to the first preview information being different from the second preview information, the first preview sticker based on the first preview information and the sticker configuration information.

In some embodiments, there are a plurality of live rooms performing live streaming simultaneously with the first live room; and the one or more instructions, when loaded and executed by the processor of the electronic device, cause the electronic device to perform:

respectively assigning sticker update requests of a plurality of live rooms to a plurality of sticker update tasks, wherein each sticker update task is assigned a sticker update request of at least one live room, and a sticker update task corresponding to the first live room includes acquiring the second preview information in response to the sticker display request including a sticker update request, and generating, in response to the first preview information being different from the second preview information, the first preview sticker based on the first preview information and the sticker configuration information.

In some embodiments, the one or more instructions, when loaded and executed by the processor of the electronic device, cause the electronic device to perform:

acquiring the second preview information from a first database, wherein the first database is configured to store preview information corresponding to a preview sticker which has been generated.

In some embodiments, the one or more instructions, when loaded and executed by the processor of the electronic device, cause the electronic device to perform:

acquiring the sticker configuration information from a second database, wherein the second database is a database corresponding to a configuration management platform.

In some embodiments, the live preview is provided with a reserve control configured to trigger reservation for the target live streaming; and the one or more instructions, when loaded and executed by the processor of the electronic device, cause the electronic device to perform:
receiving a reserve request from the second terminal, wherein the reserve request is sent in response to the reserve control being triggered; and
updating preview information corresponding to the live preview in response to the reserve request.

In some embodiments, the one or more instructions, when loaded and executed by the processor of the electronic device, cause the electronic device to perform:

receiving a cancel request from the first terminal, and sending a sticker cancel instruction to the second terminal, wherein the sticker cancel instruction instructs the second terminal to cancel display of the first preview sticker.

In some embodiments, the first preview information includes at least one of live streaming time, a live streaming theme, and a quantity of reservations; the sticker configuration information includes a sticker template; and the one or more instructions, when loaded and executed by the processor of the electronic device, cause the electronic device to perform:

generating the first preview sticker based on the sticker template and at least one of the live streaming time, the live streaming theme, or the quantity of reservations.

In some embodiments, the one or more instructions, when loaded and executed by the processor of the electronic device, cause the electronic device to perform:

providing a sticker display function for the first live room in the case that the first live room of the first terminal has been associated with the live preview, wherein the first terminal is capable of triggering the sticker display request based on the sticker display function.

In some embodiments, the one or more instructions, when loaded and executed by the processor of the electronic device, cause the electronic device to perform:

providing the sticker display function for the first live room in the case that the first live room of the first terminal has been associated with the live preview and a sticker status of the first live room satisfies a target condition.

In some embodiments, the one or more instructions, when loaded and executed by the processor of the electronic device, cause the electronic device to perform:
querying for on/off status of a preview sticker control of the first live room, wherein the on/off status indicates whether displaying a preview sticker in the live streaming interface is allowed; and
determining that the sticker status satisfies the target condition in the case that the on/off status indicates that displaying the preview sticker in the live streaming interface is allowed; or
determining that the sticker status does not satisfy the target condition in the case that the on/off status indicates that displaying the preview sticker in the live streaming interface is not allowed.

In some embodiments, the one or more instructions, when loaded and executed by the processor of the electronic device, cause the electronic device to perform:
receiving a configuration update request from the first terminal, wherein the configuration update request is triggered based on the preview sticker control of the first live room; and
updating the on/off status of the preview sticker control in response to the configuration update request.

In some embodiments, the one or more instructions, when loaded and executed by the processor of the electronic device, cause the electronic device to perform:
receiving a control create request from the first terminal; and
creating the preview sticker control in response to the control create request.

In some embodiments, the one or more instructions, when loaded and executed by the processor of the electronic device, cause the electronic device to perform:

calling an API corresponding to the preview sticker control, and querying for the on/off status of the preview sticker control.

Some embodiments of the present disclosure provide a non-transitory computer-readable storage medium storing one or more instructions therein, wherein the one or more instructions, when loaded and executed by a processor of an electronic device, cause the electronic device to perform:
displaying a live streaming interface of a first live room, wherein the first live room has been associated with a live preview;
sending a sticker display request to a server;
receiving a sticker display instruction from the server, wherein the sticker display instruction carries a first preview sticker which is generated, in response to the sticker display request, by the server based on first preview information corresponding to the live preview; and
displaying the first preview sticker in the live streaming interface in response to the sticker display instruction.

In some embodiments, the first preview sticker is also displayed in a live streaming interface of a second terminal in the first live room; the second terminal is a terminal used by an audience; and the one or more instructions, when loaded and executed by the processor of the electronic device, cause the electronic device to perform:

sending a cancel request to the server, wherein the cancel request is configured to request the server to send a sticker cancel instruction to the second terminal; and the sticker cancel instruction instructs the second terminal to cancel display of the first preview sticker.

In some embodiments, the sticker display request is sent in the case that a sticker status of the first live room satisfies a target condition; the sticker status satisfying the target condition means that on/off status of a preview sticker control of the first live room indicates that displaying a preview sticker in the live streaming interface is allowed; and the one or more instructions, when loaded and executed by a processor of an electronic device, cause the electronic device to perform:
sending a configuration update request to the server, wherein the configuration update request is triggered based on the preview sticker control; and
receiving updated on/off status of the preview sticker control from the server, wherein the updated on/off status is acquired by updating the on/off status of the preview sticker control by the server in response to the configuration update request.

In some embodiments, a computer program product is further provided. The computer program product includes a computer program, wherein the computer program, when executed by a processor, causes the processor to perform the method for creating a live preview in aforementioned embodiments.

In some embodiments, the computer program product in this embodiment of the present disclosure may be deployed on and executed by one server, a plurality of servers at the same site, or a plurality of servers disposed at different sites and interconnected through a communication network. The plurality of servers disposed at the different sites and interconnected through the communication network may form a blockchain system.

According to some embodiments of the present disclosure, a computer program product is provided. The computer program product includes a computer program, wherein the computer program, when executed by a processor, causes the processor to perform:
receiving a sticker display request from a first terminal, wherein a first live room of the first terminal has been associated with a live preview, the first terminal being a terminal used by an anchor;
generating a first preview sticker in response to the sticker display request based on first preview information corresponding to the live preview; and
sending a sticker display instruction to a second terminal in the first live room, wherein the sticker display instruction carries the first preview sticker, and instructs the second terminal to display the first preview sticker in a live streaming interface of the first live room, the second terminal being a terminal used by an audience.

In some embodiments, the computer program, when executed by the processor, causes the processor to perform:
acquiring the first preview information and sticker configuration information in response to the sticker display request; and
generating the first preview sticker based on the first preview information and the sticker configuration information.

In some embodiments, the computer program, when executed by the processor, causes the processor to perform:

generating, in response to the sticker display request including a sticker create request, the first preview sticker based on the first preview information and the sticker configuration information.

In some embodiments, the computer program, when executed by the processor, causes the processor to perform:
acquiring second preview information in response to the sticker display request including a sticker update request, wherein the second preview information is preview information corresponding to a second preview sticker which has been displayed in the first live room; and
generating, in response to the first preview information being different from the second preview information, the first preview sticker based on the first preview information and the sticker configuration information.

In some embodiments, there are a plurality of live rooms performing live streaming simultaneously with the first live room; and the computer program, when executed by the processor, causes the processor to perform:

respectively assigning sticker update requests of a plurality of live rooms to a plurality of sticker update tasks, wherein each sticker update task is assigned a sticker update request of at least one live room, and a sticker update task corresponding to the first live room includes acquiring the second preview information in response to the sticker display request including a sticker update request, and generating, in response to the first preview information being different from the second preview information, the first preview sticker based on the first preview information and the sticker configuration information.

In some embodiments, the computer program, when executed by the processor, causes the processor to perform:

acquiring the second preview information from a first database, wherein the first database is configured to store preview information corresponding to a preview sticker which has been generated.

In some embodiments, the computer program, when executed by the processor, causes the processor to perform:

acquiring the sticker configuration information from a second database, wherein the second database is a database corresponding to a configuration management platform.

In some embodiments, the live preview is provided with a reserve control configured to trigger reservation for the target live streaming; and the computer program, when executed by the processor, causes the processor to perform:
receiving a reserve request from the second terminal, wherein the reserve request is sent in response to the reserve control being triggered; and
updating preview information corresponding to the live preview in response to the reserve request.

In some embodiments, the computer program, when executed by the processor, causes the processor to perform:

receiving a cancel request from the first terminal, and sending a sticker cancel instruction to the second terminal, wherein the sticker cancel instruction instructs the second terminal to cancel display of the first preview sticker.

In some embodiments, the first preview information includes at least one of live streaming time, a live streaming theme, and a quantity of reservations; the sticker configuration information includes a sticker template; and the computer program, when executed by the processor, causes the processor to perform:

generating the first preview sticker based on the sticker template and at least one of the live streaming time, the live streaming theme, or the quantity of reservations.

In some embodiments, the computer program, when executed by the processor, causes the processor to perform:

providing a sticker display function for the first live room in the case that the first live room of the first terminal has been associated with the live preview, wherein the first terminal is capable of triggering the sticker display request based on the sticker display function.

In some embodiments, the computer program, when executed by the processor, causes the processor to perform:

providing the sticker display function for the first live room in the case that the first live room of the first terminal has been associated with the live preview and a sticker status of the first live room satisfies a target condition.

In some embodiments, the computer program, when executed by the processor, causes the processor to perform:
querying for on/off status of a preview sticker control of the first live room, wherein the on/off status indicates whether displaying a preview sticker in the live streaming interface is allowed; and
determining that the sticker status satisfies the target condition in the case that the on/off status indicates that displaying the preview sticker in the live streaming interface is allowed; or
determining that the sticker status does not satisfy the target condition in the case that the on/off status indicates that displaying the preview sticker in the live streaming interface is not allowed.

In some embodiments, the computer program, when executed by the processor, causes the processor to perform:
receiving a configuration update request from the first terminal, wherein the configuration update request is triggered based on the preview sticker control of the first live room; and
updating the on/off status of the preview sticker control in response to the configuration update request.

In some embodiments, the computer program, when executed by the processor, causes the processor to perform:
receiving a control create request from the first terminal; and
creating the preview sticker control in response to the control create request.

In some embodiments, the computer program, when executed by the processor, causes the processor to perform:

calling an API corresponding to the preview sticker control, and querying for the on/off status of the preview sticker control.

According to some embodiments of the present disclosure, a computer program product is provided. The computer program product includes a computer program, wherein the computer program, when executed by a processor, causes the processor to perform:
displaying a live streaming interface of a first live room, wherein the first live room has been associated with a live preview;
sending a sticker display request to a server;
receiving a sticker display instruction from the server, wherein the sticker display instruction carries a first preview sticker which is generated by the server in response to the sticker display request based on first preview information corresponding to the live preview; and
displaying the first preview sticker in the live streaming interface in response to the sticker display instruction.

In some embodiments, the first preview sticker is also displayed in a live streaming interface of a second terminal in the first live room; the second terminal is a terminal used by audience; and the computer program, when executed by the processor, causes the processor to perform:

sending a cancel request to the server, wherein the cancel request is configured to request the server to send a sticker cancel instruction to the second terminal; and the sticker cancel instruction instructs the second terminal to cancel display of the first preview sticker.

In some embodiments, the sticker display request is sent in the case that a sticker status of the first live room satisfies a target condition; the sticker status satisfying the target condition means that on/off status of a preview sticker control of the first live room indicates that displaying a preview sticker in the live streaming interface is allowed; and the computer program, when executed by the processor, causes the processor to perform:
sending a configuration update request to the server, wherein the configuration update request is triggered based on the preview sticker control; and
receiving updated on/off status of the preview sticker control from the server, wherein the updated on/off status is acquired by updating the on/off status of the preview sticker control by the server in response to the configuration update request.
Each embodiment of the present disclosure may be executed independently or in combination with another embodiment. Both the execution fashions fall within the protection scope of the present disclosure.

What is claimed is:

1. A method for creating a live preview, applicable to a server, comprising:
receiving a sticker display request from a first terminal, wherein a first live room of the first terminal has been associated with a live preview, and the first terminal is a terminal used by an anchor;
generating, in response to the sticker display request, a first preview sticker of a target live streaming based on first preview information corresponding to the live preview, and the target live streaming is a live streaming for which the live preview is to be created; and
sending a sticker display instruction to a second terminal in the first live room, wherein the sticker display instruction carries the first preview sticker, is configured to instruct the second terminal to display the first preview sticker in a live streaming interface of the first live room, and the second terminal is a terminal used by an audience.

2. The method according to claim 1, wherein said generating, in response to the sticker display request, the first preview sticker based on the first preview information corresponding to the live preview comprises:
acquiring the first preview information and sticker configuration information in response to the sticker display request; and
generating the first preview sticker based on the first preview information and the sticker configuration information.

3. The method according to claim 2, wherein said generating the first preview sticker based on the first preview information and the sticker configuration information comprises:
generating, in response to the sticker display request comprising a sticker create request, the first preview sticker based on the first preview information and the sticker configuration information.

4. The method according to claim 2, wherein said generating the first preview sticker based on the first preview information and the sticker configuration information comprises:
acquiring second preview information in response to the sticker display request comprising a sticker update request, wherein the second preview information is preview information corresponding to a second preview sticker, and the second preview sticker has been displayed in the first live room; and
generating, in response to the first preview information being different from the second preview information, the first preview sticker based on the first preview information and the sticker configuration information.

5. The method according to claim 4, wherein a plurality of live rooms including the first live room are performing live streaming simultaneously; and the method further comprises:
respectively assigning sticker update requests of a plurality of live rooms to a plurality of sticker update tasks, wherein each sticker update task is assigned a sticker update request of at least one live room, and a sticker update task corresponding to the first live room comprises acquiring the second preview information in response to the sticker display request comprising the sticker update request, and generating, in response to the first preview information being different from the second preview information, the first preview sticker based on the first preview information and the sticker configuration information.

6. The method according to claim 4, wherein said acquiring the second preview information comprises:
acquiring the second preview information from a first database, wherein the first database is configured to store preview information corresponding to a preview sticker which has been generated.

7. The method according to claim 2, wherein said acquiring the sticker configuration information comprises:
acquiring the sticker configuration information from a second database, wherein the second database is a database corresponding to a configuration management platform.

8. The method according to claim 1, wherein the live preview is provided with a reserve control configured to trigger reservation for the target live streaming; and the method further comprises:
receiving a reserve request from the second terminal, wherein the reserve request is sent in response to the reserve control being triggered; and
updating preview information corresponding to the live preview in response to the reserve request.

9. The method according to claim 1, further comprising:
receiving a cancel request from the first terminal, and sending a sticker cancel instruction to the second terminal, wherein the sticker cancel instruction is configured to instruct the second terminal to cancel display of the first preview sticker.

10. The method according to claim 2, wherein the first preview information comprises at least one of live streaming time, a live streaming theme, or a quantity of reservations; the sticker configuration information comprises a sticker template; and
said generating the first preview sticker based on the first preview information and the sticker configuration information comprises:
generating the first preview sticker based on the sticker template and at least one of the live streaming time, the live streaming theme, or the quantity of reservations.

11. The method according to claim 1, further comprising:
providing a sticker display function for the first live room in the case that the first live room of the first terminal has been associated with the live preview, wherein the first terminal is capable of triggering the sticker display request based on the sticker display function.

12. The method according to claim 11, wherein said providing the sticker display function for the first live room in the case that the first live room of the first terminal has been associated with the live preview comprises:
providing the sticker display function for the first live room in the case that the first live room of the first terminal has been associated with the live preview and sticker status of the first live room satisfies a target condition.

13. The method according to claim 12, wherein determining whether the sticker status of the first live room satisfies the target condition comprises:
querying for on/off status of a preview sticker control of the first live room, wherein the on/off status indicates whether displaying a preview sticker in the live streaming interface is allowed; and
determining that the sticker status satisfies the target condition in the case that the on/off status indicates that displaying the preview sticker in the live streaming interface is allowed; or
determining that the sticker status does not satisfy the target condition in the case that the on/off status indicates that displaying the preview sticker in the live streaming interface is not allowed.

14. The method according to claim 13, further comprising:
receiving a configuration update request from the first terminal, wherein the configuration update request is triggered based on the preview sticker control of the first live room; and
updating the on/off status of the preview sticker control in response to the configuration update request.

15. The method according to claim 13, further comprising:
receiving a control create request from the first terminal; and
creating the preview sticker control in response to the control create request.

16. The method according to claim 13, wherein said querying for the on/off status of the preview sticker control of the first live room comprises:
calling an application programming interface (API) corresponding to the preview sticker control, and querying for the on/off status of the preview sticker control.

17. A method for creating a live preview, applicable in an anchor terminal, comprising:
displaying a live streaming interface of a first live room, wherein the first live room has been associated with a live preview;
sending a sticker display request to a server, wherein the sticker display request is configured to request displaying a first preview sticker of a target live streaming on the live streaming interface of the first live room, and the target live streaming is a live streaming for which the live preview is to be created;
receiving a sticker display instruction from the server, wherein the sticker display instruction carries the first preview sticker which is generated, in response to the sticker display request, by the server based on first preview information corresponding to the live preview; and
displaying the first preview sticker in the live streaming interface in response to the sticker display instruction.

18. The method according to claim 17, wherein
the first preview sticker is also displayed in a live streaming interface of a second terminal in the first live room; and the second terminal is a terminal used by audience; and
the method further comprises:
sending a cancel request to the server, wherein the cancel request is configured to request the server to send a sticker cancel instruction to the second terminal; and the sticker cancel instruction is configured to instruct the second terminal to cancel display of the first preview sticker.

19. The method according to claim 17, wherein
the sticker display request is sent in the case that a sticker status of the first live room satisfies a target condition, wherein the target condition is satisfied in the case that on/off status of a preview sticker control of the first live room indicates that displaying a preview sticker in the live streaming interface is allowed; and
the method further comprises:
sending a configuration update request to the server, wherein the configuration update request is triggered based on the preview sticker control; and
receiving updated on/off status of the preview sticker control from the server, wherein the updated on/off status is acquired by updating the on/off status of the preview sticker control by the server in response to the configuration update request.

20. An electronic device, comprising:
one or more processors; and
a memory configured to store one or more instructions executable by the one or more processors,
wherein the one or more processors, when loading and executing the one or more instructions, are caused to perform:
displaying a live streaming interface of a first live room, wherein the first live room has been associated with a live preview;
sending a sticker display request to a server, wherein the sticker display request is configured to request displaying a first preview sticker of a target live streaming on the live streaming interface of the first live room, and the target live streaming is a live streaming for which the live preview is to be created;
receiving a sticker display instruction from the server, wherein the sticker display instruction carries the first preview sticker which is generated, in response to the sticker display request, by the server based on first preview information corresponding to the live preview; and
displaying the first preview sticker in the live streaming interface in response to the sticker display instruction.
